(19) United States
(12) Patent Application Publication
(10) Pub. No.: US 2022/0063182 A1
(43) Pub. Date: Mar. 3, 2022

(54) METHODS OF FORMING LENS FOR CORRECTION OF HIGH-ORDER ABERRATIONS USING ADDITIVE FABRICATION PROCESS

(71) Applicant: Ovitz Corporation, Rochester, NY (US)

(72) Inventors: Nicolas Scott BROWN, Rochester, NY (US); Joung Yoon KIM, Seoul (KR)

(21) Appl. No.: 17/461,315

(22) Filed: Aug. 30, 2021

Related U.S. Application Data
(60) Provisional application No. 63/072,796, filed on Aug. 31, 2020.

(51) Int. Cl. B29C 64/112; B29C 64/268; B29C 64/336; B33Y 10/00; B33Y 80/00

(52) U.S. Cl. CPC B29C 64/112; B29C 64/268; B29L 2011/0041; B33Y 10/00; B33Y 80/00; B29C 64/336

(57) ABSTRACT

A method for fabricating a contact lens by an additive fabrication process includes joining a first portion of the contact lens with a second portion of the contact lens and joining a third portion of the contact lens with at least one of the first portion and the second portion of the contact lens. A center of a correction region of the contact lens may be offset from a center of the contact lens. The first portion and the second portion may include a first material and a second material at different ratios. The first portion and the second portion of the contact lens may include a first material and a second material having different sizes.

### RELATED APPLICATIONS

This application claims the benefit of, and priority to, U.S. Provisional Patent Application Ser. No. 63/072,796, filed Aug. 31, 2020, which is incorporated by reference herein in its entirety.

### TECHNICAL FIELD

This relates generally to methods for making a contact lens using additive fabrication process, and particularly to methods for making a contact lens for correction of high-order aberrations using additive fabrication process.

### BACKGROUND

Eyes are important organs, which play a critical role in human's visual perception. An eye has a roughly spherical shape and includes multiple elements, such as cornea, lens, vitreous humour, and retina. Imperfections in these components can cause reduction or loss of vision. For example, too much or too little optical power in the eye (e.g., near-sightedness or far-sightedness) and astigmatism can lead to blurring of the vision.

Corrective lenses (e.g., glasses and contact lenses) are frequently used to compensate for blurring caused by too much or too little optical power and/or astigmatism. However, when eyes have higher-order aberrations (e.g., aberrations higher than astigmatism in the Zernike polynomial model of aberrations, such as coma, spherical aberration, trefoil, quadrafoil, etc.), conventional corrective lenses have not been effective at compensating for all of the aberrations associated with the eyes, resulting in blurry images even when corrective lenses are used.

### SUMMARY

Accordingly, there is a need for corrective lenses that can compensate for higher-order aberrations. However, there is a variation in the structure and orientation of an eye among patients (and even between different eyes of a same patient), and thus, a contact lens placed on an eye will settle in different positions and orientations for different patients (or different eyes). Proper alignment of the corrective lens to the patient's eye is required in order to provide an accurate correction or compensation of the higher-order aberrations in the eye. In addition, high order aberrations vary among different eyes. For example, even a left eye and a right eye of a same person may have different high order aberrations. Thus, a contact lens made for a particular eye (e.g., based on the position information, such as lateral displacements and orientation, as well as vision information, such as high order aberrations, for the eye) is required for effective correction or compensation of the higher-order aberrations in the eye. Making such customized contact lenses using conventional methods can be costly and time consuming. In addition, it is challenging to form certain correction patterns for higher order aberrations using conventional lens fabrication methods.

The above deficiencies and other problems associated with conventional methods are reduced or eliminated by methods described herein.

In accordance with some embodiments, a method includes fabricating a contact lens by an additive fabrication process, including: joining a first portion of the contact lens with a second portion of the contact lens and joining a third portion of the contact lens with at least one of the first portion and the second portion of the contact lens. A center of a correction region of the contact lens is offset from a center of the contact lens.

In accordance with some embodiments, a method includes fabricating a contact lens by an additive fabrication process, including: joining a first portion of the contact lens with a second portion of the contact lens and joining a third portion of the contact lens with at least one of the first portion and the second portion of the contact lens. The first portion of the contact lens includes a first material and a second material different from the first material at a first ratio and the second portion of the contact lens includes the first material and the second material at a second ratio that is different from the first ratio.

In accordance with some embodiments, a method includes fabricating a contact lens by an additive fabrication process, including: joining a first portion of the contact lens with a second portion of the contact lens and joining a third portion of the contact lens with at least one of the first portion and the second portion of the contact lens. The first portion of the contact lens includes a first material of a first size and the second portion of the contact lens includes a second material, different from the first material, of a second size different from the first size.

In some embodiments, the first material has a first refractive index, and the second material has a second refractive index that is different from the first refractive index.

In some embodiments, the first portion of the contact lens excludes the second material, and the second portion of the contact lens excludes the first material.

In some embodiments, the third portion of the contact lens includes the first material and the second material at a third ratio that is different from at least one of: the first ratio and the second ratio.

In accordance with some embodiments, a method includes fabricating a contact lens by an additive fabrication process, including: joining a first portion of the contact lens with a second portion of the contact lens; subsequent to joining the first portion of the contact lens with the second portion of the contact lens, joining a third portion of the contact lens with at least one of the first portion and the second portion of the contact lens; exposing the second portion of the contact lens to first light having a first property; and exposing the third portion of the contact lens to second light having a second property different from the first property.

In some embodiments, the first light has a first intensity and the second light has a second intensity different from the first intensity.

In some embodiments, the first light has a first energy and the second light has a second energy different from the first energy.

In some embodiments, the first portion of the contact lens is cured by exposing the first portion of the contact lens to the first light, and the second portion of the contact lens is cured by exposing the second portion of the contact lens to the second light.

In some embodiments, the method includes exposing the third portion of the contact lens to third light having a third property different from at least one of the first property and the second property.

In some embodiments, a center of a correction region of the contact lens is offset from a center of the contact lens.

In some embodiments, at least one of the first portion, the second portion, and the third portion of the contact lens includes hydrogel.

In some embodiments, joining the first portion of the contact lens with the second portion of the contact lens includes forming the second portion of the contact lens in contact with the first portion of the contact lens.

In some embodiments, forming the second portion of the contact lens includes depositing a precursor material for the second portion of the contact lens, and curing the precursor material for the second portion of the contact lens.

In some embodiments, joining the third portion of the contact lens includes forming the third portion of the contact lens in contact with at least one of the first portion and the second portion of the contact lens.

In some embodiments, forming the third portion of the contact lens includes depositing a precursor material for the third portion of the contact lens and curing the precursor material for the third portion of the contact lens.

In some embodiments, the first portion of the contact lens is formed by depositing a precursor material for the first portion of the contact lens, and curing the precursor material for the first portion of the contact lens.

In some embodiments, the first portion of the contact lens is formed without curing any precursor material.

In some embodiments, the first portion of the contact lens is formed by machining.

In some embodiments, the first portion of the contact lens is formed by molding.

In some embodiments, the method includes machining one or more surfaces of the contact lens.

In some embodiments, a center region of the contact lens has a first stiffness; and a peripheral region of the contact lens has a second stiffness less than the first stiffness.

In accordance with some embodiments, a contact lens is made by any method described herein.

In some embodiments, the contact lens includes a scleral lens.

Thus, the disclosed embodiments provide contact lenses and methods of collecting position information for contact lenses, which can be used to accurately determine a position of a position reference point (e.g., a visual axis) of an eye relative to a contact lens (or vice versa), in conjunction with vision information. Such information, in turn, allows design and manufacturing of customized (e.g., personalized) contact lenses that can compensate for higher-order aberrations in a particular eye.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a schematic diagram showing a system for vision characterization in accordance with some embodiments.

FIGS. 1B and 1C illustrate optical components of an optical device in accordance with some embodiments.

FIG. 1D illustrates wavefront sensing with the optical device shown in FIGS. 1B and 1C, in accordance with some embodiments.

FIG. 1E illustrates imaging with the optical device shown in FIGS. 1B and 1C, in accordance with some embodiments.

FIGS. 1F and 1G illustrate optical components of an optical device in accordance with some other embodiments.

FIG. 1H is a front view of a measurement instrument in accordance with some embodiments.

FIG. 2 is a block diagram illustrating electronic components of an optical device in accordance with some embodiments.

FIGS. 3A-3D are schematic diagrams illustrating correction of higher-order aberrations in accordance with some embodiments.

FIG. 3E is a schematic diagram illustrating a perspective view of an eye and aspects of lens positioning that relate to design and fitting of the scleral contact lens.

FIG. 3F is a schematic diagram illustrating a plan view of the eye and the lens shown in FIG. 3E, taken along the visual axis.

FIG. 3G shows an image of a reference lens with marks in accordance with some embodiments.

FIGS. 4A-4C are flow diagrams illustrating a method of forming a contact lens in accordance with some embodiments.

FIG. 5A is a schematic diagram illustrating a three-dimensional (3D) printer for forming a contact lens in accordance with some embodiments.

FIG. 5B is a schematic diagram illustrating fabrication of a contact lens in accordance with some embodiments.

FIG. 5C is a schematic diagram illustrating formation of a contact lens for correction of high order aberrations in accordance with some embodiments.

FIG. 6A is a schematic diagram illustrating a three-dimensional (3D) printer for depositing two or more materials in accordance with some embodiments.

FIG. 6B is a schematic diagram illustrating an example of material composition across a contact lens in accordance with some embodiments.

FIG. 6C is a schematic diagram illustrating another example of material composition across a contact lens in accordance with some embodiments.

FIG. 6D is a schematic diagram illustrating surface smoothing of a contact lens formed by an additive fabrication process in accordance with some embodiments.

FIG. 7 is a schematic diagram illustrating an offset of a correction region of a contact lens in accordance with some embodiments.

FIG. 8 is a schematic diagram illustrating a cross-sectional view of a scleral contact lens in accordance with some embodiments.

FIGS. 9A and 9B are flow diagrams illustrating a method of fabricating a contact lens by an additive fabrication process in accordance with some embodiments.

FIG. 10 is a flow diagram illustrating a method of fabricating a contact lens by an additive fabrication process in accordance with some embodiments.

FIG. 11 is a flow diagram illustrating a method of fabricating a contact lens by an additive fabrication process in accordance with some embodiments.

FIG. 12 is a flow diagram illustrating a method of fabricating a contact lens by an additive fabrication process in accordance with some embodiments.

These figures are not drawn to scale unless indicated otherwise.

### DETAILED DESCRIPTION

Reference will be made to embodiments, examples of which are illustrated in the accompanying drawings. In the following description, numerous specific details are set forth in order to provide a thorough understanding of the various described embodiments. However, it will be apparent to one of ordinary skill in the art that the various described embodiments may be practiced without these particular details. In other instances, methods, procedures, components, circuits, and networks that are well-known to those of ordinary skill in the art are not described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first image sensor could be termed a second image sensor, and, similarly, a second image sensor could be termed a first image sensor, without departing from the scope of the various described embodiments. The first image sensor and the second image sensor are both image sensors, but they are not the same image sensor.

The terminology used in the description of the embodiments herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting (the stated condition or event)” or “in response to detecting (the stated condition or event),” depending on the context.

A corrective lens (e.g., contact lens) designed to compensate for higher-order aberrations of an eye needs accurate positioning on an eye. If a corrective lens designed to compensate for higher-order aberrations of an eye is not placed accurately, the corrective lens may not be effective in compensating for higher-order aberrations of the eye and may even exacerbate the higher-order aberrations.

One of the additional challenges is that when a corrective lens (e.g., contact lens) is used to compensate for higher-order aberrations of an eye, an apex of a corrective lens is not necessarily positioned on a visual axis of the eye. Thus, a relative position between the visual axis of the eye and the apex of the corrective lens needs to be reflected in the design of the corrective lens. This requires accurate measurements of the visual axis of the eye and a position of the corrective lens on the eye and fabrication of a corrective lens that compensates for the offset between the position of the visual axis of the eye and the position of the corrective lens. Because the position of the corrective lens on an eye depends largely on the specific structure of the eyeball (e.g., the size and curvature) and the surrounding structure (e.g., eyelids), a corrective lens customized for a particular eye is required so that the correction or compensation pattern of the corrective lens is placed in the correct position.

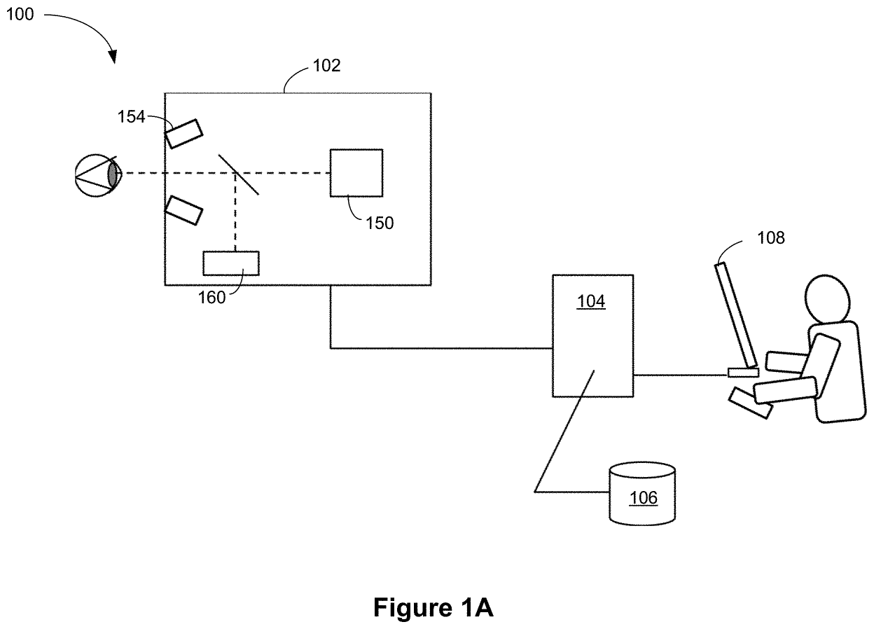

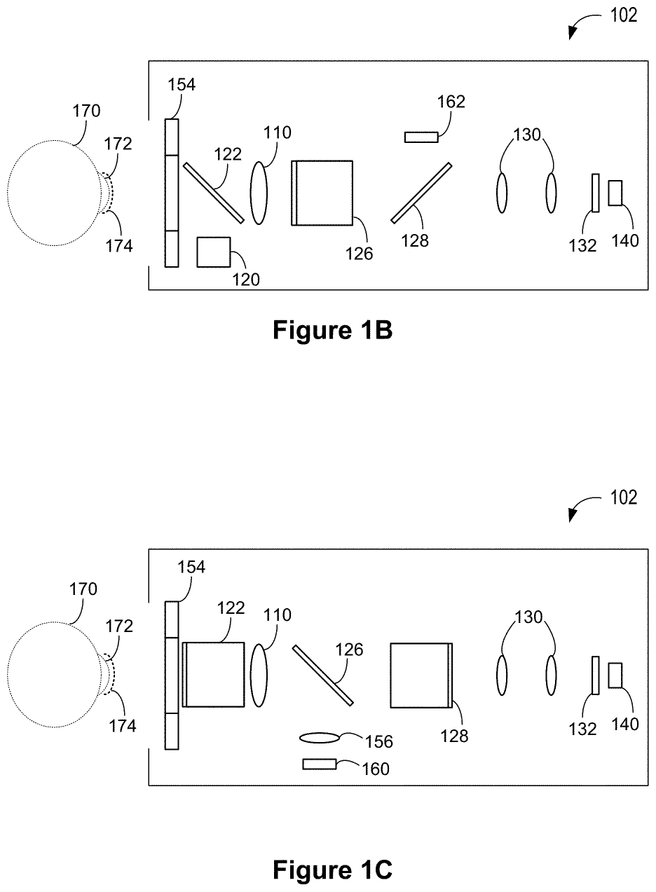

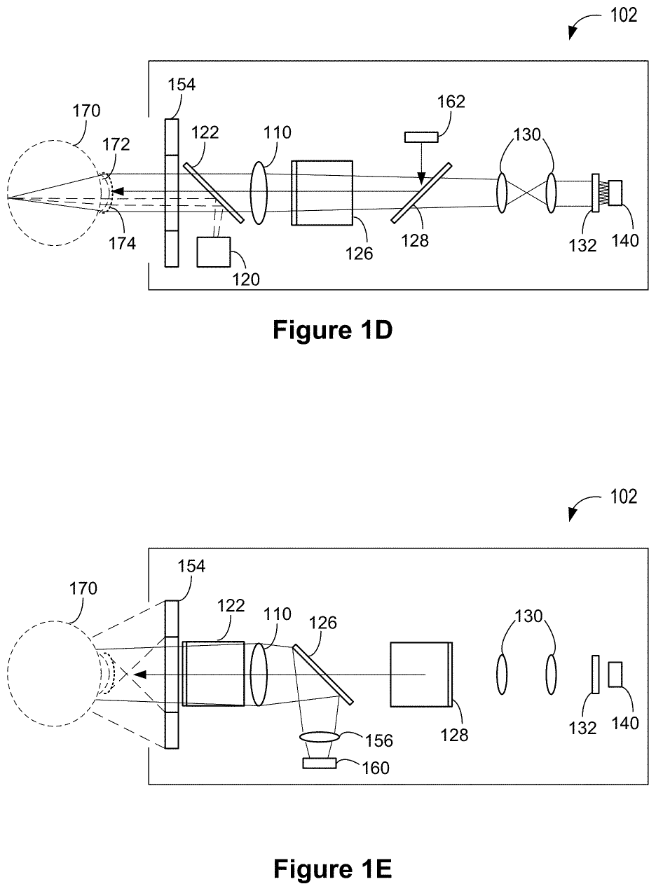

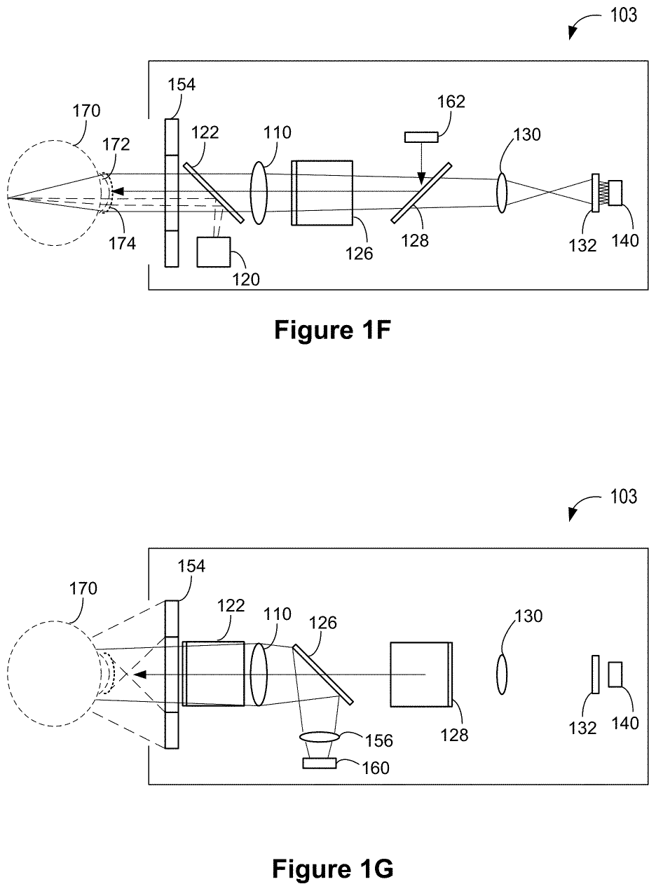

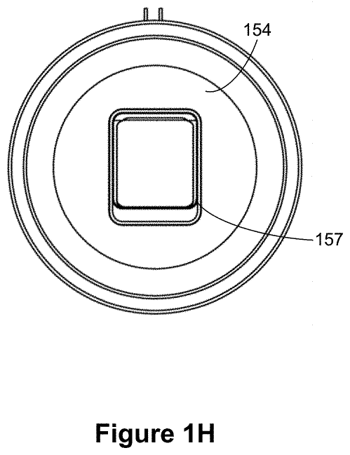

FIG. 1A is a schematic diagram showing a system 100 for vision characterization in accordance with some embodiments. The system 100 includes a measurement device 102, a computer system 104, a database 106, and a display device 108. The measurement device 102 performs a vision characterization of an eye of a patient (e.g., using light source 154 and imaging sensor 160) and provides imaging results and vision profile metrics of the characterized eye. The measurement device 102 includes a wavefront measurement device, such as a Shack-Hartmann wavefront sensor 150, that is configured to perform wavefront measurements. The display device 108 shows the imaging results and vision profile metrics acquired by the measurement device 102. In some cases, the display device 108 may provide a user (e.g., operator, optometrist, viewer, or practitioner) with one or more options or prompts to correct, validate, or confirm displayed results. The database 106 stores imaging results and vision profile metrics acquired by the measurement device 102 as well as any verified information provided by the user of the system 100. In response to receiving the results from the measurement device 102 and validation of displayed results from the user, the system 100 may generate a correction lens (e.g., contact lens) fabrication file for the patient that is stored in the database 106.

The computer system 104 may include one or more computers or central processing units (CPUs). The computer system 104 is in communication with each of the measurement device 102, the database 106, and the display device 108.

FIGS. 1B-1E illustrate optical components of the measurement device 102 in accordance with some embodiments. FIG. 1B shows a side view (e.g., a side elevational view) of the optical components of the measurement device 102, and FIG. 1C is a top view (e.g., a plan view) of the optical components of the measurement device 102. One or more lenses 156 and second image sensor 160 shown in FIG. 1C are not shown in FIG. 1B to avoid obscuring other components of the measurement device 102 shown in FIG. 1B. In FIG. 1C, pattern 162 is not shown to avoid obscuring other components of the measurement device 102 shown in FIG. 1C.

The measurement device 102 includes lens assembly 110. In some embodiments, lens assembly 110 includes one or more lenses. In some embodiments, lens assembly 110 is a doublet lens. For example, a doublet lens is selected to reduce spherical aberration and other aberrations (e.g., coma and/or chromatic aberration). In some embodiments, lens assembly 110 is a triplet lens. In some embodiments, lens assembly 110 is a singlet lens. In some embodiments, lens assembly 110 includes two or more separate lenses. In some embodiments, lens assembly 110 includes an aspheric lens. In some embodiments, a working distance of lens assembly 110 is between 10-100 mm (e.g., between 10-90 mm, 10-80 mm, 10-70 mm, 10-60 mm, 10-50 mm, 15-90 mm, 15-80 mm, 15-70 mm, 15-60 mm, 15-50 mm, 20-90 mm, 20-80 mm, 20-70 mm, 20-60 mm, 20-50 mm, 25-90 mm, 25-80 mm, 25-70 mm, 25-60 mm, or 25-50 mm). In some embodiments, when the lens assembly includes two or more lenses, an effective focal length of a first lens (e.g., the lens positioned closest to the pupil plane) is between 10-150 mm (e.g., between 10-140 mm, 10-130 mm, 10-120 mm, 10-110 mm, 10-100 mm, 10-90 mm, 10-80 mm, 10-70 mm, 10-60 mm, 10-50 mm, 15-150 mm, 15-130 mm, 15-120 mm, 15-110 mm, 15-100 mm, 15-90 mm, 15-80 mm, 15-70 mm, 15-60 mm, 15-50 mm, 20-150 mm, 20-130 mm, 20-120 mm, 20-110 mm, 20-100 mm, 20-90 mm, 20-80 mm, 20-70 mm, 20-60 mm, 20-50 mm, 25-150 mm, 25-130 mm, 25-120 mm, 25-110 mm, 25-100 mm, 25-90 mm, 25-80 mm, 25-70 mm, 25-60 mm, 25-50 mm, 30-150 mm, 30-130 mm, 30-120 mm, 30-110 mm, 30-100 mm, 30-90 mm, 30-80 mm, 30-70 mm, 30-60 mm, 30-50 mm, 35-150 mm, 35-130 mm, 35-120 mm, 35-110 mm, 35-100 mm, 35-90 mm, 35-80 mm, 35-70 mm, 35-60 mm, 35-50 mm, 40-150 mm, 40-130 mm, 40-120 mm, 40-110 mm, 40-100 mm, 40-90 mm, 40-80 mm, 40-70 mm, 40-60 mm, 40-50 mm, 45-150 mm, 45-130 mm, 45-120 mm, 45-110 mm, 45-100 mm, 45-90 mm, 45-80 mm, 45-70 mm, 45-60 mm, 45-50 mm, 50-150 mm, 50-130 mm, 50-120 mm, 50-110 mm, 50-100 mm, 50-90 mm, 50-80 mm, 50-70 mm, or 50-60 mm). In some embodiments, for an 8 mm pupil diameter, the lens diameter is 16-24 mm. In some embodiments, for a 7 mm pupil diameter, the lens diameter is 12-20 mm. In some embodiments, the f-number of lens assembly is between 2 and 5. The use of a common lens assembly (e.g., lens assembly 110) in both a wavefront sensor and a contact lens center sensor allows the integration of the wavefront sensor and the contact lens center sensor without needing large diameter optics.

The measurement device 102 also includes a wavefront sensor. In some embodiments, the wavefront sensor includes first light source 120, lens assembly 110, an array of lenses 132 (also called herein lenslets), and first image sensor 140. In some embodiments, the wavefront sensor includes additional components (e.g., one or more lenses 130). In some embodiments, the wavefront sensor does not include such additional components.

First light source 120 is configured to emit first light and transfer the first light emitted from the first light source toward eye 170, as depicted in FIG. 1D.

FIGS. 1B-1E include eye 170, its components (e.g., cornea 172), and contact lens 174 to illustrate the operations of the measurement device 102 with eye 170 and contact lens 174. By performing measurements on eye 170 with contact lens 174, aberrations in eye 170 as modified by contact lens 174 may be detected. In addition, the position of contact lens 174 relative to eye 170 may be detected. However, eye 170, its components, and contact lens 174 are not part of the measurement device 102.

Turning back to FIG. 1B, in some embodiments, first light source 120 is configured to emit light of a single wavelength or a narrow band of wavelengths. Exemplary first light source 120 includes a laser (e.g., a laser diode) or a light-emitting diode (LED).

In some embodiments, first light source 120 includes one or more lenses to change the divergence of the light emitted from first light source 120 so that the light, after passing through the one or more lenses, is collimated.

In some embodiments, first light source 120 includes a pinhole (e.g., having a diameter of 1 mm or less, such as 400 μm, 500 μm, 600 μm, 700 μm, 800 μm, 900 μm, and 1 mm).

In some cases, an anti-reflection coating is applied on a back surface (and optionally, a front surface) of lens assembly 110 to reduce reflection. In some embodiments, first light source 120 is configured to transfer the first light emitted from first light source 120 off an optical axis of the measurement device 102 (e.g., an optical axis of lens assembly 110), as shown in FIG. 1D (e.g., the first light emitted from first light source 120 propagates parallel to, and offset from, the optical axis of lens assembly 110). This reduces back reflection of the first light emitted from first light source 120, by cornea 172, toward first image sensor 140. In some embodiments, the wavefront sensor includes a quarter-wave plate to reduce back reflection, of the first light, from lens assembly 110 (e.g., light reflected from lens assembly 110 is attenuated by the quarter-wave plate). In some embodiments, the quarter-wave plate is located between beam steerer 122 and first image sensor 140.

First image sensor 140 is configured to receive light, from eye 170, transmitted through lens assembly 110 and the array of lenses 132. In some embodiments, the light from eye 170 includes light scattered at a retina or fovea of eye 170 (in response to the first light from first light source 120). For example, as shown in FIG. 1D, light from eye 170 passes multiple optical elements, such as beam steerer 122, lens assembly 110, beam steerer 126, beam steerer 128, and lenses 130, and reaches first image sensor 140.

Beam steerer 122 is configured to reflect light from light source 120 and transmit light from eye 170, as shown in FIG. 1D. Alternatively, beam steerer 122 is configured to transmit light from light source 120 and reflect light from eye 170. In some embodiments, beam steerer 122 is a beam splitter (e.g., 50:50 beam splitter, polarizing beam splitter, etc.). In some embodiments, beam steerer 122 is a wedge prism, and when first light source 120 is configured to have a linear polarization, the polarization of the light emitted from first light source 120 is configured to reflect at least partly by the wedge prism. Light of a polarization that is orthogonal to the linear polarization of the light emitted from first light source 120 is transmitted through the wedge prism. In some cases, the wedge prism also reduces light reflected from cornea 172 of eye 170.

In some embodiments, beam steerer 122 is tilted at such an angle (e.g., an angle between the optical axis of the measurement device 102 and a surface normal of beam steerer 122 is at an angle less than 45°, such as 30°) so that the space occupied by beam steerer 122 is reduced.

In some embodiments, the measurement device 102 includes one or more lenses 130 to modify a working distance of the measurement device 102.

The array of lenses 132 is arranged to focus incoming light onto multiple spots, which are imaged by first image sensor 140. As in Shack-Hartmann wavefront sensor, an aberration in a wavefront causes displacements (or disappearances) of the spots on first image sensor 140. In some embodiments, a Hartmann array is used instead of the array of lenses 132. A Hartmann array is a plate with an array of apertures (e.g., through-holes) defined therein.

In some embodiments, one or more lenses 130 and the array of lenses 132 are arranged such that the wavefront sensor is configured to measure a reduced range of optical power. A wavefront sensor that is capable of measuring a wide range of optical power may have less accuracy than a wavefront sensor that is capable of measuring a narrow range of optical power. Thus, when a high accuracy in wavefront sensor measurements is desired, the wavefront sensor can be designed to cover a narrow range of optical power. For example, a wavefront sensor for diagnosing low and medium myopia can be configured with a narrow range of optical power between 0 and −6.0 diopters, with its range centering around −3.0 diopters. Although such a wavefront sensor may not provide accurate measurements for diagnosing hyperopia (or determining a prescription for hyperopia), the wavefront sensor would provide more accurate measurements for diagnosing myopia (or determining a prescription for myopia) than a wavefront sensor that can cover both hyperopia and myopia (e.g., from −6.0 to +6.0 diopters). In addition, there are certain populations in which it is preferable to maintain a center of the range at a non-zero value. For example, in some Asian populations, the optical power may range from +6.0 to −14.0 diopters (with the center of the range at −4.0 diopters), whereas in some Caucasian populations, the optical power may range from +8.0 to −12.0 diopters (with the center of the range at −2.0 diopters). The center of the range can be shifted by moving the lenses (e.g., one or more lenses 130 and/or the array of lenses 132). For example, defocusing light from eye 170 can shift the center of the range.

The measurement device 102 further includes a contact lens center sensor (or a corneal vertex sensor). In some embodiments, the contact lens center sensor includes lens assembly 110, second light source 154, and second image sensor 160. In some embodiments, as shown in FIG. 1C, second image sensor 160 is distinct from first image sensor 140. In some embodiments, the wavefront sensor includes additional components that are not included in the contact lens center sensor (e.g., array of lenses 132).

Second light source 154 is configured to emit second light and transfer the second light emitted from second light source 154 toward eye 170. As shown in FIG. 1E, in some embodiments, second light source 154 is configured to transfer the second light emitted from second light source 154 toward eye 170 without transmitting the second light emitted from second light source 154 through lens assembly 110 (e.g., second light from second light source 154 is directly transferred to eye 170 without passing through lens assembly 110).

In some embodiments, the measurement device 102 includes beam steerer 126 configured to transfer light from eye 170, transmitted through lens assembly 110, toward first image sensor 140 and/or second image sensor 160. For example, when the measurement device 102 is configured for wavefront sensing (e.g., when light from first light source 120 is transferred toward eye 170), beam steerer 126 transmits light from eye 170 toward first image sensor 140, and when the measurement device 102 is configured for contact lens center determination (e.g., when light from second light source 154 is transferred toward eye 170), beam steerer 126 transmits light from eye 170 toward second image sensor 160.

Second light source 154 is distinct from first light source 120. In some embodiments, first light source 120 and second light source 154 emit light of different wavelengths (e.g., first light source 120 emits light of 900 nm wavelength, and second light source 154 emits light of 800 nm wavelength; alternatively, first light source 120 emits light of 850 nm wavelength, and second light source 154 emits light of 950 nm wavelength).

In some embodiments, beam steerer 126 is a dichroic mirror (e.g., a mirror that is configured to transmit the first light from first light source 120 and reflect the second light from second light source 154, or alternatively, reflect the first light from first light source 120 and transmit the second light from second light source 154). In some embodiments, beam steerer 126 is a movable mirror (e.g., a mirror that can flip or rotate to steer light toward first image sensor 140 and second image sensor 160). In some embodiments, beam steerer 126 is a beam splitter. In some embodiments, beam steerer 126 is configured to transmit light of a first polarization and reflect light of a second polarization that is distinct from (e.g., orthogonal to) the first polarization. In some embodiments, beam steerer 126 is configured to reflect light of the first polarization and transmit light of the second polarization.

In some embodiments, second light source 154 is configured to project a predefined pattern of light on the eye. In some embodiments, second light source 154 is configured to project an array of spots on the eye. In some embodiments, the array of spots is arranged in a grid pattern.

In some embodiments, second light source 154 includes one or more light emitters (e.g., light-emitting diodes) and diffuser (e.g., a diffuser plate having an array of spots).

FIGS. 1F and 1G illustrate optical components of a measurement instrument 103 in accordance with some other embodiments. Measurement instrument 103 is similar to the measurement device 102 shown in FIGS. 1B-1E except that measurement instrument 103 includes only one lens 130.

FIG. 1H is a front view of the measurement device 102 in accordance with some embodiments. The side view of the measurement device 102 shown in FIG. 1H corresponds to a view of the measurement device 102 seen from a side that is adjacent to second light source 154. In FIG. 1H, the measurement device 102 includes second light source 154, which has a circular shape with a rectangular hole 157 defined in it. Second light source 154 shown in FIG. 1H projects a pattern of light.

Turning back to FIG. 1E, second image sensor 160 is configured to receive light, from eye 170. In some embodiments, the light from eye 170 includes light reflected from cornea 172 of eye 170 (in response to the second light from second light source 154). For example, as shown in FIG. 1E, light from eye 170 (e.g., light reflected from cornea 172) interacts with multiple optical elements, such as lens assembly 110, beam steerer 122, beam steerer 126, and one or more lenses 156, and reaches second image sensor 160.

In some embodiments, the lenses in the contact lens center sensor (e.g., lens assembly 110 and one or more lenses 156) are configured to image a pattern of light projected on cornea 172 onto second image sensor 160.

In some embodiments, second image sensor 160 collects an image of a combination of eye 170 and contact lens 174. From the image, the position and orientation of contact lens 174 relative to eye 170 (e.g., relative to a pupil center or a visual axis of eye 170) may be determined, as described herein.

In some embodiments, the measurement device 102 includes pattern 162 and beam steerer 128. Pattern 162 is an image that is projected toward eye 170 to facilitate positioning of eye 170. In some embodiments, pattern 162 includes an image of an object (e.g., balloon), an abstract shape (e.g., a cross), or a pattern of light (e.g., a shape having a blurry edge).

In some embodiments, beam steerer 128 is a dichroic mirror (e.g., a mirror that is configured to transmit the light from eye 170 and reflect light from pattern 162, or alternatively, reflect light from eye 170 and transmit light from pattern 162). In some embodiments, beam steerer 128 is a movable mirror. In some embodiments, beam steerer 128 is a beam splitter. In some embodiments, beam steerer 128 is configured to transmit light of a first polarization and reflect light of a second polarization that is distinct from (e.g., orthogonal to) the first polarization. In some embodiments, beam steerer 128 is configured to reflect light of the first polarization and transmit light of the second polarization.

FIG. 1D illustrates operation of the measurement device 102 for wavefront sensing without operations for determining a contact lens center and FIG. 1E illustrates operation of the measurement device 102 for determining a contact lens center without wavefront sensing. In some embodiments, the measurement device 102 sequentially operates between wavefront sensing and determining a contact lens center. For example, in some cases, the measurement device 102 performs wavefront sensing and subsequently, determines a contact lens center. In some other cases, the measurement device 102 determines a contact lens center, and subsequently performs wavefront sensing. In some embodiments, the measurement device 102 switches between wavefront sensing and determining a contact lens center. In some embodiments, the measurement device 102 repeats wavefront sensing and determining a contact lens center. In some embodiments, the measurement device 102 operates for wavefront sensing concurrently with determining a contact lens center (e.g., light from first light source 120 and light from second light source 154 are delivered toward eye 170 at the same time, and first image sensor 140 and second image sensor 160 collect images at the same time). For brevity, such details are not repeated herein.

In some embodiments, light from pattern 162 is projected toward eye 170 while the measurement device 102 operates for wavefront sensing (as shown in FIG. 1D). In some embodiments, light from pattern 162 is projected toward eye 170 while device operates for determining a contact lens center (as shown in FIG. 1E).

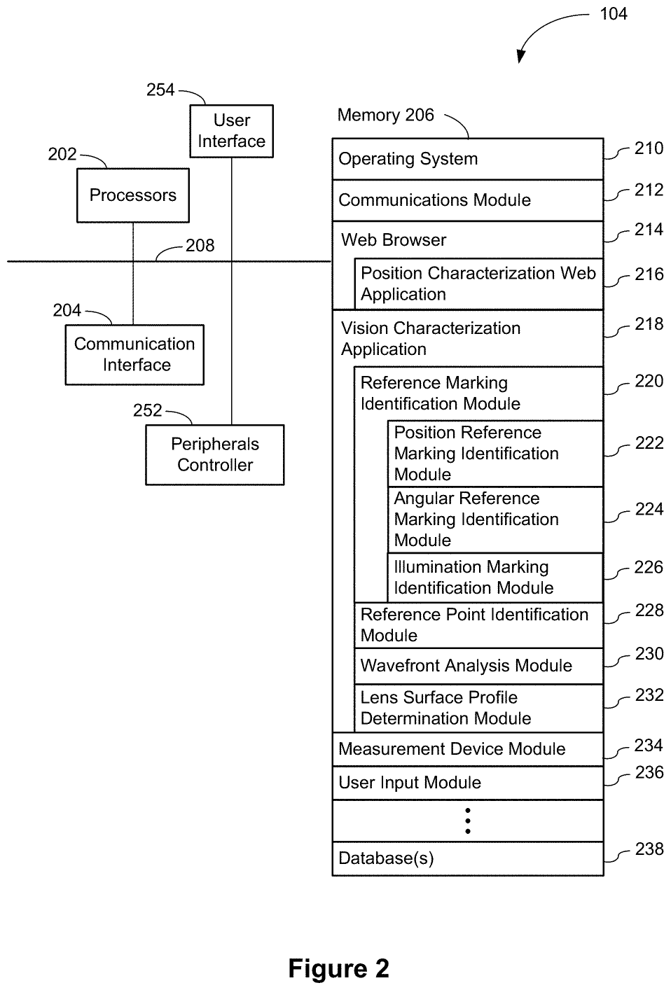

FIG. 2 shows block diagram illustrating electronic components of computer system 104 in accordance with some embodiments. Computer system 104 includes one or more processing units 202 (central processing units, application processing units, application-specific integrated circuit, etc., which are also called herein processors), one or more network or other communications interfaces 204, memory 206, and one or more communication buses 208 for interconnecting these components. In some embodiments, communication buses 208 include circuitry (sometimes called a chipset) that interconnects and controls communications between system components. In some embodiments, system 100 includes a user interface 254 (e.g., a user interface having the display device 108, which can be used for displaying acquired images, one or more buttons, and/or other input devices). In some embodiments, computer system 104 also includes peripherals controller 252, which is configured to control operations of components of the measurement device 102, such as first light source 120, first image sensor 140, second light source 154, and second image sensor 160 (e.g., initiating respective light sources to emit light, and/or receiving information, such as images, from respective image sensors).

In some embodiments, communications interfaces 204 include wired communications interfaces and/or wireless communications interfaces (e.g., Wi-Fi, Bluetooth, etc.).

Memory 206 of computer system 104 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 206 may optionally include one or more storage devices remotely located from the processors 202. Memory 206, or alternately the non-volatile memory device(s) within memory 206, comprises a computer readable storage medium (which includes a non-transitory computer readable storage medium and/or a transitory computer readable storage medium). In some embodiments, memory 206 includes a removable storage device (e.g., Secure Digital memory card, Universal Serial Bus memory device, etc.). In some embodiments, memory 206 or the computer readable storage medium of memory 206 stores the following programs, modules and data structures, or a subset thereof:
operating system 210 that includes procedures for handling various basic system services and for performing hardware dependent tasks;
network communication module (or instructions) 212 that is used for connecting computer system 104 to other computers (e.g., clients and/or servers) via one or more communications interfaces 204 and one or more communications networks, such as the Internet, other wide area networks, local area networks, metropolitan area networks, and so on;
vision characterization application 218, or position characterization web application 216 that runs in a web browser 214, that characterizes position information from an image of an eye and markings;
measurement device module 234 that controls operations of the light sources and the image sensors in the measurement device 102 (e.g., for receiving images from the measurement device 102);
user input module 236 configured for handling user inputs on computer system 104 (e.g., pressing of buttons on computer system 104 or pressing of buttons on a user interface, such as a keyboard, mouse, or touch-sensitive display, that is in communication with computer system 104); and
one or more databases 238 (e.g., database 106) that store information acquired by the measurement device 102.

In some embodiments, memory 206 also includes one or both of:
user information (e.g., information necessary for authenticating a user of computer system 104); and
patient information (e.g., optical measurement results and/or information that can identify patients whose optical measurement results are stored in the one or more databases 238 on computer system 104).

In some embodiments, vision characterization application 218, or vision characterization web application 216, includes the following programs, modules and data structures, or a subset or superset thereof:
reference marking identification module 220 configured for identifying (e.g., automatically identifying) one or more reference markings in an image captured (e.g., recorded, acquired) by the measurement device 102, which may include one or more of the following:
   periphery reference marking identification module 222 configured for identifying (e.g., automatically identifying) one or more periphery reference markings in an image captured (e.g., recorded, acquired) by the measurement device 102;
   angular reference marking identification module 224 configured for identifying (e.g., automatically identifying) one or more angular reference markings in an image captured (e.g., recorded, acquired) by the measurement device 102; and
   illumination marking identification module 226 configured for identifying (e.g., automatically identifying) one or more illumination markings in an image captured (e.g., recorded, acquired) by the measurement device 102;
reference point identification module 228 configured for identifying (e.g., automatically identifying) a position reference point of a patient's eye based on an image captured (e.g., recorded, acquired) by the measurement device 102;
wavefront analysis module 230 configured for analyzing the wavefront measured for a patient's eye(s) using the measurement device 102; and
lens surface profile determination module 232 configured for determining a lens surface profile for a patient's eye(s) based the wavefront measured for a patient's eye and the positions of reference markings.

In some embodiments, wavefront analysis module 230 includes the following programs and modules, or a subset or superset thereof:
an analysis module configured for analyzing images received from first image sensor 140; and
a first presentation module configured for presenting measurement and analysis results from first analysis module (e.g., graphically displaying images received from first image sensor 140, presenting aberrations shown in images received from first image sensor 140, sending the results to another computer, etc.).

In some embodiments, measurement device module 234 includes the following programs and modules, or a subset or superset thereof:
a light source module configured for initiating first light source 120 (through peripherals controller 252) to emit light;
an image sensing module configured for receiving images from first image sensor 140;
a light source module configured for initiating second light source 154 (through peripherals controller 252) to emit light;
an image sensing module configured for receiving images from second image sensor 160;
an image acquisition module configured for capturing one or more images of a patient's eye(s) using the measurement device 102; and
an image stabilization module configured for reducing blurring during acquisition of images by image sensors.

In some embodiments, the computer system 104 may include other modules such as:
an analysis module configured for analyzing images received from second image sensor 160 (e.g., determining a center of a projected pattern of light);
a presentation module configured for presenting measurement and analysis results from second analysis module (e.g., graphically displaying images received from second image sensor 160, presenting cornea curvatures determined from images received from second image sensor 160, sending the results to another computer, etc.);
a spot array analysis module configured for analyzing spot arrays (e.g., measuring displacements and/or disappearances of spots in the spot arrays); and
a centering module configured for determining a center of a projected pattern of light.

In some embodiments, a first image sensing module initiates execution of the image stabilization module to reduce blurring during acquisition of images by first image sensor 140, and a second image sensing module initiates execution of the image stabilization module to reduce blurring during acquisition of images by second image sensor 160.

In some embodiments, a first analysis module initiates execution of spot array analysis module to analyze spot arrays in images acquired by first image sensor 140, and a second analysis module initiates execution of spot array analysis module to analyze spot arrays in images acquired by second image sensor 160.

In some embodiments, a first analysis module initiates execution of spot array analysis module to analyze spot arrays in images acquired by first image sensor 140, and a second analysis module initiates execution of centering module to analyze images acquired by second image sensor 160.

In some embodiments, the one or more databases 238 may store any of: wavefront image data, including information representing the light received by the first image sensor (e.g., images received by the first image sensor), and pupil image data, including information representing the light received by the second image sensor (e.g., images received by the second image sensor).

Each of the above identified modules and applications correspond to a set of instructions for performing one or more functions described above. These modules (i.e., sets of instructions) need not be implemented as separate software programs, procedures or modules, and thus various subsets of these modules may be combined or otherwise re-arranged in various embodiments. In some embodiments, memory 206 may store a subset of the modules and data structures identified above. Furthermore, memory 206 may store additional modules and data structures not described above.

Notwithstanding the discrete blocks in FIG. 2, these figures are intended to be a functional description of some embodiments, although, in some embodiments, the discrete blocks in FIG. 2 can be a structural description of functional elements in the embodiments. One of ordinary skill in the art will recognize that an actual implementation might have the functional elements grouped or split among various components. In practice, and as recognized by those of ordinary skill in the art, items shown separately could be combined and some items could be separated. For example, in some embodiments, measurement device module 234 is part of vision characterization application 218 (or vision characterization web application 216). In other embodiments, reference marking identification module 220, wavefront analysis module 230, and lens surface profile determination module 232 are implemented as separate applications. In some embodiments, one or more programs, modules, or instructions may be implemented in measurement device 102 instead of computer system 104.

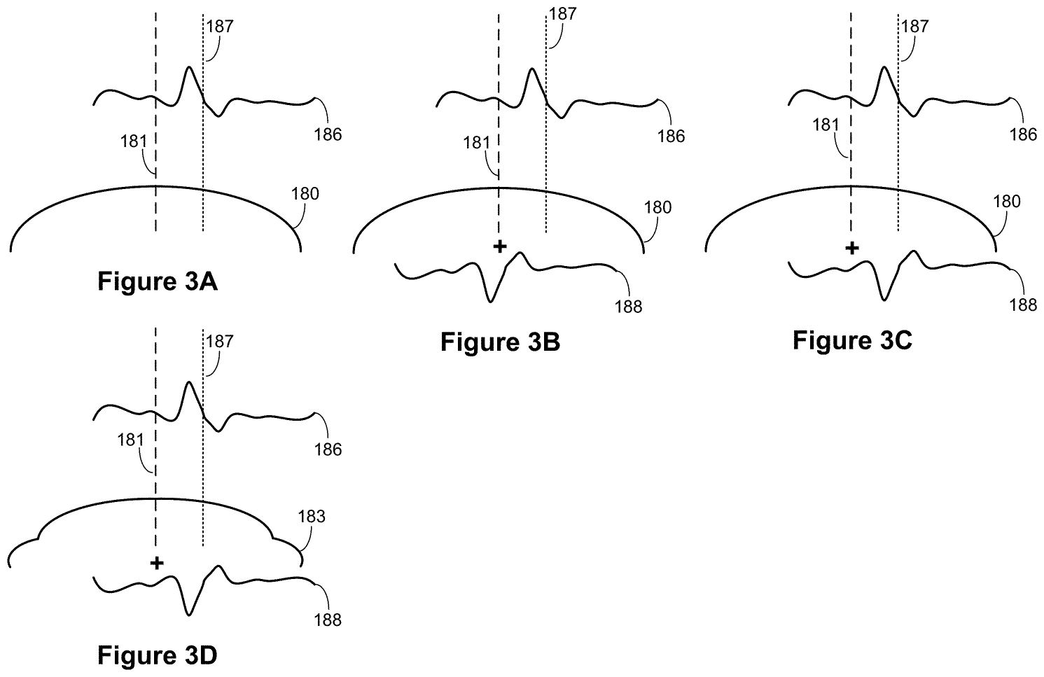

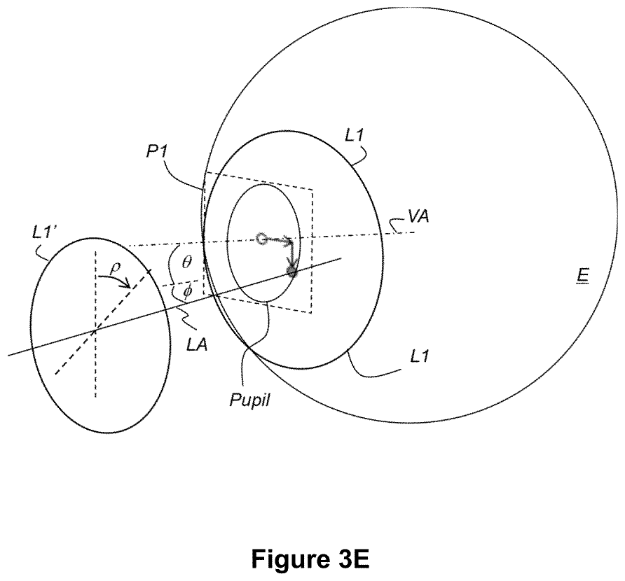

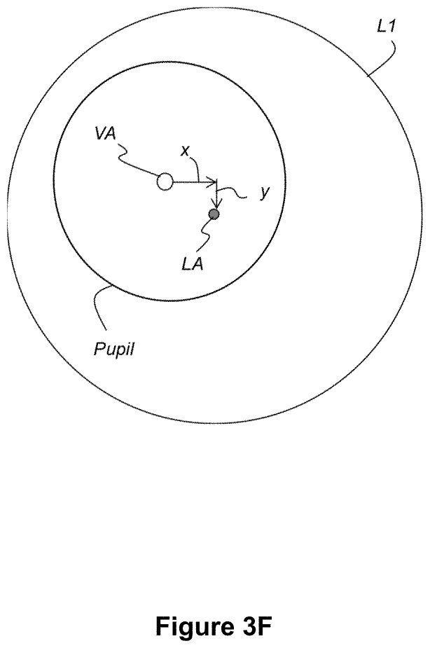

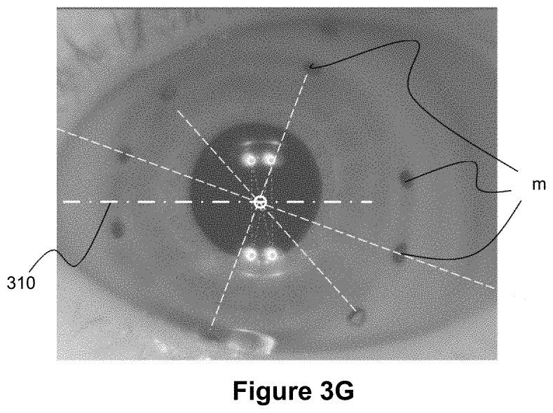

FIGS. 3A-3D are schematic diagrams illustrating correction of higher-order aberrations in accordance with some embodiments.

FIG. 3A illustrates a surface profile of a contact lens 180 without higher-order correction. As a result, an eye wearing the contact lens 180 may see higher-order aberrations represented by line 186. The visual axis 187 of the eye is typically not aligned with the centerline 181 of the contact lens 180, and thus, the measured higher-order aberrations are not aligned with the center of the contact lens 180.

FIG. 3B illustrates modification of the surface profile of the contact lens 180 by superposing a surface profile 188 configured to compensate for the higher-order aberrations. However, when the surface profile 188 is positioned around the centerline 181 of the contact lens 180 as shown in FIG. 3B, the combined surface profile is not effective in reducing the higher-order aberrations, as the surface profile 188 is offset from the higher-order aberrations measured along the visual axis 187 of the eye.

FIG. 3C illustrates modification of the surface profile of the contact lens 180 by superposing the surface profile 188 configured to compensate for the higher-order aberrations where the surface profile 188 is positioned around the visual axis 187 of the eye instead of the centerline 181 of the contact lens 180. By modifying the surface profile of the contact lens 180 by superposing the surface profile 188 with an offset (e.g., the surface profile 188 is in line with the visual axis 187 of the eye), a lens with the modified surface profile can better compensate for higher-order aberrations.

FIG. 3D is similar to FIG. 3C except that the modification of the surface profile can be applied to a multifocal lens 183.

Although FIGS. 3A-3D are used to illustrate the importance of the position of the contact lens relative to the visual axis, the orientation and tilt of the contact lens relative to the visual axis are also important.

FIG. 3E is a schematic diagram illustrating a perspective view of an eye and aspects of lens positioning that relate to design and fitting of the scleral contact lens. FIG. 3F is a schematic diagram illustrating a plan view of the eye and the lens shown in FIG. 3E, taken along the visual axis (e.g., FIG. 3F shows a view of a plane perpendicular to the visual axis).

Coordinates x and y are considered to lie on a plane P1 that is orthogonal to the visual axis VA of the eye E. Angles θ and ϕ relate to orthogonal angular components for skew of the lens axis LA away from visual axis VA.

Although the lens L1 is positioned on a surface of the eye E (e.g., over the cornea and sclera), the lens L1′ offset from the surface of the eye E is shown in FIG. 3E to illustrate the rotation of the lens L1 without obscuring other aspects of FIG. 3E. Angle measurement ρ (also called the orientation) relates to rotation of the lens L1 (e.g., clockwise from a 12 o'clock reference direction). In FIG. 3E, the rotation is measured about the lens axis LA. In some cases, the rotation is measured about the visual axis VA of the eye E.

In some cases, a reference lens with markings is used to assist with determination of the lens position. The reference lens, also called a predicate lens, may serves as an indicator of translation with respect to a visual axis of an eye. In some configurations, the reference lens has a same size as a contact lens (e.g., scleral lens). In some configurations, the reference lens has an optical power (e.g., an optical power to compensate for myopia, hyperopia, or presbyopia, and optionally astigmatism). However, the reference lens may not be configured to compensate for higher-order aberrations. Compared to a contact lens, which is designed to be worn by a patient throughout a day, the reference lens is typically designed to be worn temporarily for diagnostic purposes (e.g., while the patient is at a clinic for one or more measurements by a measurement device, such as measurement device 102, which may be used for prescription of a customized contact lens).

For example, a reference lens with marks, shown in FIG. 3G, may be used to determine a position and orientation of the reference lens while the reference lens is positioned on an eye. As shown in FIG. 3G, the marks m are arranged in a way so that a center of the lens corresponds to a center of the marks m and an orientation of the lens may be indicated by a rotation of the marks m relative to a reference line 310 (e.g., a horizontal line, a vertical line, or a predefined reference line having a particular orientation).

As explained above, the position of a corrective lens on an eye varies among people and even between different eyes of a same person. Thus, a corrective lens customized for a particular eye is required so that the correction or compensation pattern of the corrective lens is placed in the correct position relative to the particular eye.

Making such customized corrective lenses using conventional methods can be costly and time consuming. As described herein, a corrective lens (e.g., a contact lens) can be formed using an additive fabrication process, which allows formation of a corrective lens more rapidly and cost effectively.

In addition, it is challenging to form certain correction patterns for higher order aberrations using conventional lens fabrication methods. The methods described herein enable formation of correction patterns that are not readily achievable using conventional manufacturing methods. In some cases, a combination of two or more materials may be used during the additive fabrication process to provide a lens having a non-constant refractive index profile, similar to a gradient refractive index (GRIN) lens. In some cases, different portions (having a same material or different materials) of a lens are exposed to different levels of energy, which, in turn, contribute to a variation of the refractive index across the lens.

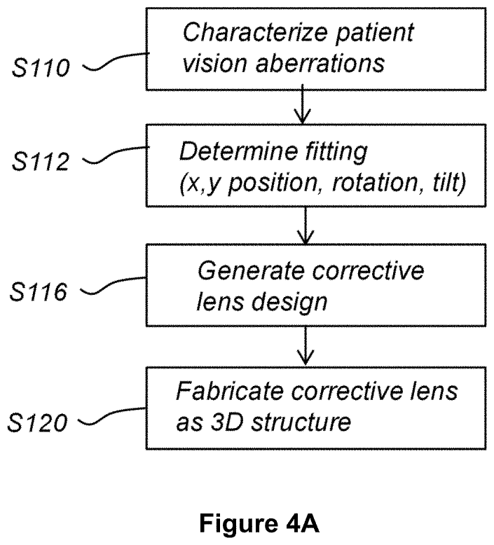

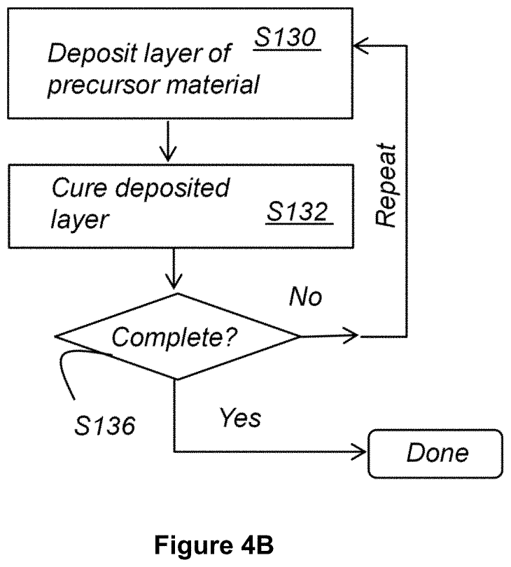

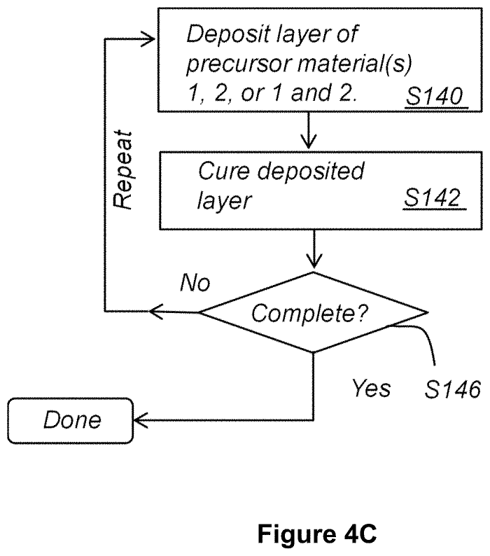

FIGS. 4A-4C are flow diagrams illustrating a method of forming a contact lens in accordance with some embodiments.

FIG. 4A shows a flow sequence for contact lens fabrication using three-dimensional (3D) printing to form the lens with localized gradient index (GRIN) features. This arrangement configures the lens to have a pattern of internal regions, with different portions of the lens volume having different indices of refraction, so that the lens bends light differently within different portions of the lens according to the pattern. The pattern of variable refraction in the fabricated lens corresponds to the mapping of higher-order aberrations generated for the patient, so that the lens corrects one or more of the higher-order aberrations.

The patient's vision is characterized in operation S110 using an appropriate instrument, such as a Shack-Hartmann or other waveform-based device, as described for FIG. 1A, or using ray tracing or optical coherence tomography (OCT). This identifies one or more higher-order aberrations that need to be corrected by the lens.

With a predicate (or “precursor”) lens positioned against the eye (as shown in FIG. 3G), a fitting operation S112 then determines factors for fitting the corrective lens, including x, y positioning, angulation, and tilt, for example. A corrective lens design operation S116 then forms a lens design file according to input from operations S110 and S112. A fabrication operation S120 can then fabricate the corrective lens by additive manufacture using one or more materials.

When a single material is used, the fabrication operation S120 includes operations S130, S132, S136 shown in FIG. 4B. Operation S130 deposits each layer of lens material using 3D printing. In some embodiments, curing operation S132 then cures each deposited layer, varying the refractive index of the deposited material using light energy or other curing material or other agent. In some embodiments, the deposited material is a self-curing material that does not need any radiation for curing. Test operation S136 checks for completeness, and operations S130 and S132 are repeated until the lens is fully formed from the stack of applied layers.

When multiple materials are used, the fabrication operation S120 includes operations S140, S142, and S146 shown in FIG. 4C. Operation S140 deposits each layer as a layer of a first material, or of a second material, or of a combination of the first and second materials. Curing operation S142 then cures each deposited layer. Use of different materials can vary the refractive index of the deposited structure. Curing can use light energy or other curing material, such as a catalyst or other agent. Curing can vary the light energy for any of the multiple materials, as described with respect to FIG. 4B. Test operation S146 checks for completeness, and operations S140 and S142 are repeated until the lens is fully formed from the stack of deposited layers.

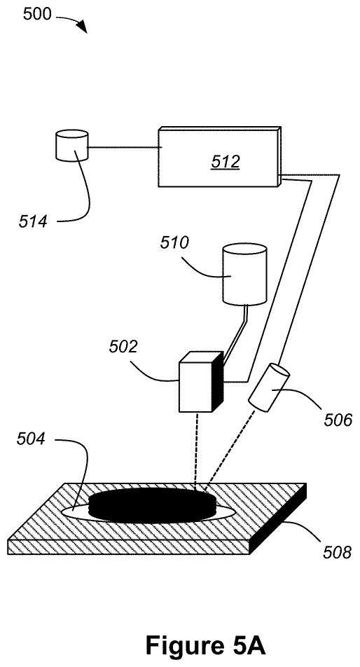

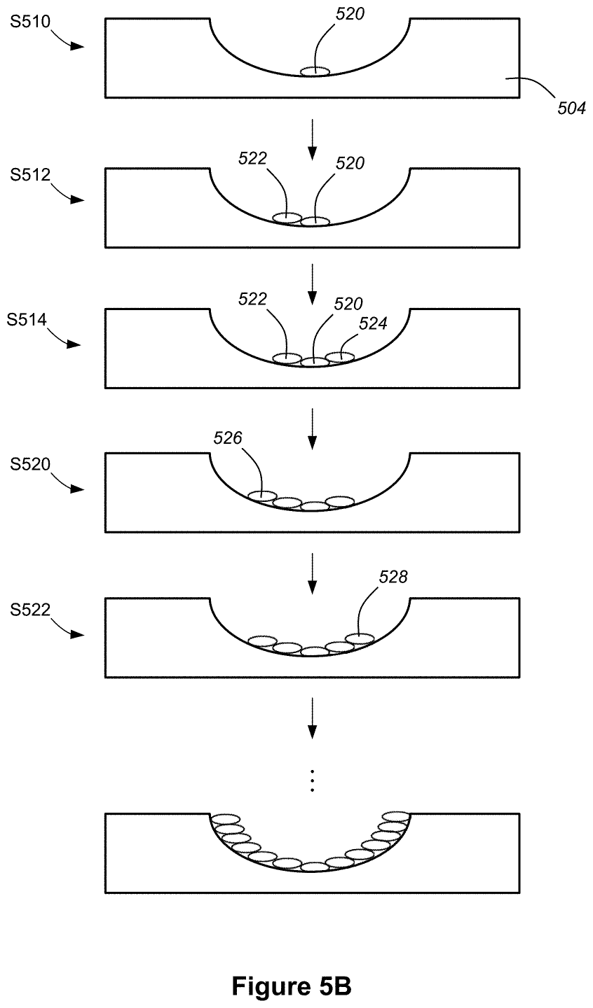

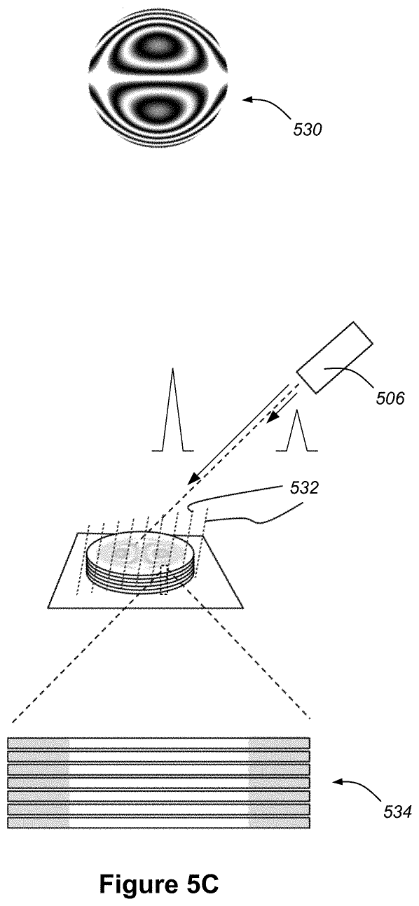

FIG. 5A is a schematic diagram illustrating a three-dimensional (3D) printer 500 for forming a contact lens in accordance with some embodiments. The 3D printer 500 shown in FIG. 5A is simplified for explanatory purposes.

The 3D printer 500 has a print head 502 that deposits layers of a lens material into a suitable mold 504 that is shaped for the anterior or posterior surface of the patient lens. A UV laser, UV or deep blue LED, visible spectrum or IR emitting laser, other high-energy light source, or radiation source 506 provides the curing energy for each successive layer of the deposited material. Alternatively, a chemical agent can be selectively applied to the layer for curing. Either the mold 504 or a combination of the print head 502 and the radiation source 506 or both are on a movable stage 508 that allows deposition of individual, adjacent lines or swaths (lines a few pixels wide), and scanning of the layer for curing.

In some embodiments, the 3D printer 500 has multiple print heads 502 (or multiple nozzles in a single print head). Multiple print heads/nozzles can be used for increased speed of fabrication.

A reservoir 510 of lens material holds a supply of a lens material, such as a nanocomposite-material or hydrogel or other polymer or mixture, that can be cured to form the lens with variable refractive index n that can change within the volume. The print head 502 deposits each layer, and the deposited material is cured (e.g., by exposure to a radiation from the radiation source 506), voxel by voxel, to form the lens. In some embodiments, the radiation source 506 is used to cure the deposited material.

Printing the lens structure to impart a refractive pattern follows steps of translating the print head 502 into a respective position relative to the lens being formed, ejecting a droplet of material at a time onto the lens structure being formed, and curing the deposited droplet (e.g., using UV light, from one or more energy sources), controlled by one or more processors 512 (e.g., microprocessors of a computer). The one or more processors 512 also control continuous staged movement of the lens relative to the print head 502 and radiation sources 506 in order to deposit and cure drops that form each layer. These steps repeat under computer control, typically thousands of times, forming the lens voxel by voxel. In some embodiments, the one or more processors 512 are coupled with a storage device 514, which stores instructions, which, when executed by the one or more processors, cause the one or more processors to perform the operations described herein. In some embodiments, the storage device 514 include the lens design file that includes information representing a surface profile of the lens for correction of higher-order aberrations.

In some embodiments, the print head 502 includes a piezo-electric actuator that generates a pressure pulse sufficient to eject each droplet of the lens material towards the existing surface being formed in the mold 504. The droplet can be deposited on top of previously ejected droplets (as shown in FIG. 5B), which may be partially or fully cured.

In some embodiments, the lens is formed on a substrate that is formed from a variety of materials; the substrate can become part of the lens, or the lens can be removed from the substrate. For applications in which the substrate becomes part of the optical-element, the substrate may be optically transmissive, reflective, or absorptive. For example, in applications where the optical-element is optically transmissive and the substrate becomes a part of the optical-element, it is desirable for the substrate to be optically transparent.

After deposition of the lens material from the print head 502, the lens being formed can be positioned with respect to a radiation source, such as a laser for selective-curing of the deposited material, voxel by voxel. The laser or other radiation source can be scanned, or can utilize a scan mirror for folding the curing light beam and moving it in a raster pattern across the deposited pattern.

As used herein, selective-curing refers to localized radiation about voxels, activating the organic-host matrix of lens material. Activation of the organic-host matrix can solidify the deposited material. Selective-curing can mean zero-curing, partial-curing, or full-curing, which respectively means not solidifying, partially solidifying, or fully solidifying the material. In some embodiments, various degrees of treatment are applied to the polymer to change optical and physical characteristics of the polymer.

In some embodiments, the 3D printer includes two or more radiation sources. In some embodiments, the two or more radiation sources include a first radiation source for partial curing of the material and a second radiation source for fully curing the material. In some embodiments, the two or more radiation sources include a first radiation source for local curing and a second radiation source for flood curing, which cures (partially or fully) all the lens material. In some embodiments, the two or more radiation sources include light sources of different wavelengths. In addition, various curing catalysts/precipitators can be added to the deposited polymers to facilitate curing.

Curing of each deposited layer forms a pattern that can have variable index of refraction according to modulation applied to the curing energy. Varying the curing energy to a polymer such as a nanocomposite polymer can change the refractive index n correspondingly.

The UV laser or LED can emit ultraviolet light with wavelengths between 2 and 380 nanometer and in in the near-UV range, typically considered to be between about 320 and 380 nanometers (nm). This can allow rapid curing without high radiant energy levels.

For light and other radiant energy sources, curing energy is a factor of intensity and duration. Methods used herein can vary either or both intensity and duration of laser or other light source to modulate curing energy in order to achieve suitable optical and/or physical characteristics of the deposited polymer.

Curing can use two UV sources, including sources that form overlapping light cones on the target deposited droplet. Power can be at levels where the applied material is substantially cured only in the area of light beam overlap.

The exposure period for the deposited droplet can be during a period of time shorter than 250 milliseconds and preferably shorter than 50 milliseconds. A short exposure time can help to reduce the impact of curing energy on the surrounding region and to reduce the time needed for fabrication.

A first UV source can emit energy of a first wavelength range and a second source can emit light of a second wavelength range different from the first. Each source can be optimized for a particular material, or the two sources can combine to cure both materials. The timing of both light sources can be synchronized to suit the curing process. For example, one source can be energized for a first time period, such as to maintain heat of the deposited droplet at a needed level for surface conformance; subsequently both can be energized to cure the deposited material.

The respective droplet sizes for first and second materials can be different. Curing energy output can be adjusted to adapt to different droplet sizes and material volumes.

Materials used for forming the corrective lens can include various types of hydrogels that exhibit varying levels of water content. This can include hydroxyethylmethacrylate (HEMA) based hydrogels of varying water content, non-HEMA based hydrogels of varying water content, silicon-based gas-permeable materials such as silicone-methacrylate and fluorosilicone acrylate, low/zero water acrylics, and silicone hydrogels, for example.

A formulation containing a precursor of the lens material may have a low viscosity to facilitate depositing. The precursor of the lens material may have a rapid buildup of yield stress to stabilize the “printed image” until the deposited material can be cured/polymerized/cross-linked. The precursor of the lens material may have a surface energy matching that of the substrate to preserve the resolution of the printed image on the substrate either by avoiding beading-up or spreading-out of the printed image.

The formulation may include a cross-linkable/polymerizable monomer as a liquid phase solvent. The viscosity and/or thixotropy of the formulation can be increased by dissolving polymer in the monomer. In some embodiments, all of the monomers are converted into polymer, without any remaining monomer.

In some embodiments, yield stress promoters are added to the formulation. This manufacturing strategy reduces or eliminates extractables. In some embodiments, a nonreactable solvent is added to the polymer. This compensates for the swelling that the lens will experience when hydrated, and can help to minimize aberrations and reduce birefringence and shear stresses resulting from the hydration. Reducing the shear stresses decreases the likelihood of delamination.

In some embodiments, each polymer to be deposited is formulated to minimize volume change and swelling during the solvent exchange with water. For contact lenses, avoiding toxic extractables is an important consideration. In some embodiments, a UV initiator is added to the formulation.

To further minimize extractables, polymerization may be driven further by a short thermal cycle. To facilitate this, a thermal initiator is added to the formulation. Dual purpose photo-/thermalinitiators are well known, e.g. Vazo 52 or Vazo 64. If the solvent, including reactable monomers, swells the substrate, it can form an Inter-penetrating Network (IPN), which improves adhesion of the successive layers and thereby the strength of the aggregate layered structure.

In some embodiments, the polymer has the ability to adequately swell the surface of the substrate thereby giving it the ability to form the IPN in order to generate good adhesion between the successive layers. In some embodiments, the cured successive layers have approximately the same swelling factor in water as the substrate polymer. This avoids the formation of destructive shear stresses during the swelling process for soft lenses.

In some embodiments, deposited polymers include any of a number of monomers, including methylmethacrylate (MMA), silicone (SI), fluorine (FL), Hydroxyethyl-methacrylate (HEMA), methacrylic acid (MAA) and n vinyl pyrolidone (NVP) monomers, ethylene glycol dimethacrylate (EGDMA).

The deposited materials can alternately include various types of nanocomposite lens materials engineered for corrective lens printing.

The lens surface can be further conditioned as final steps in fabrication, such as by polishing or other treatment.

FIG. 5B is a schematic diagram illustrating fabrication of a contact lens in accordance with some embodiments.

At step S510, a first portion 520 of a contact lens is located on a mold 504 (by deposition of the first portion 520 of the contact lens or a corresponding precursor material on the mold 504).

At step S512, a second portion 522 of the contact lens is joined with the first portion 520 of the contact lens (e.g., by deposition of the second portion 522 of the contact lens or a corresponding precursor material and curing the first portion 520, the second portion 522, or both).

At step S514, a third portion 524 of the contact lens is joined with the first portion 520 of the contact lens (e.g., by deposition of the third portion 524 of the contact lens or a corresponding precursor material and curing the first portion 520, the third portion 524, or both).

At step S520, a fourth portion 526 of the contact lens is joined with the second portion 522 of the contact lens (e.g., by deposition of the fourth portion 526 of the contact lens or a corresponding precursor material and curing the second portion 522, the fourth portion 526, or both).

At step S522, a fifth portion 528 of the contact lens is joined with the third portion 524 of the contact lens (e.g., by deposition of the fifth portion 528 of the contact lens or a corresponding precursor material and curing the third portion 524, the fifth portion 528, or both).

Similar operations are repeated until the entire contact lens or a relevant portion thereof (e.g., a portion with a pattern that corrects higher-order aberrations, a peripheral portion for contact with sclera, etc.) is formed.

Although FIG. 5B shows operations of forming a contact lens using a mold with a concave surface (e.g., an anterior surface of the contact lens is in contact with the concave surface during fabrication), a mold with a convex surface may be used (e.g., a posterior surface of the contact lens is in contact with the convex surface during fabrication). In some embodiments, a contact lens made be formed on a planar surface.

FIG. 5C is a schematic diagram illustrating formation of a contact lens for correction of high order aberrations in accordance with some embodiments.

Shown in FIG. 5C is a graphical representation 530 of an exemplary higher-order aberrations corresponding to a higher-order Zernike function.

FIG. 5C also shows that the curing energy (e.g., laser curing energy) is modulated as it scans the deposited lens material (e.g., along scan lines 532), in a pattern corresponding to the mapping of aberrations for the patient. For example, higher curing energy is applied where a higher index of refraction is needed, and lower curing energy is applied where a lower index of refraction is needed. In another example, depending on the deposited lens material, lower curing energy is applied where a higher index of refraction is needed, and higher curing energy is applied where a lower index of refraction is needed. Thus, without changing surface shape or contour, a refractive index profile of the contact lens is varied across the contact lens by modulating energy applied to each deposited inner layer, as shown in the cross section 534. In some embodiments, the refractive index profile of the contact lens is varied in three dimensions (e.g., the refractive index of a particular location in a lower layer is different from the refractive index of a corresponding location, such as a location that has a corresponding lateral position to the particular location, in a higher layer).

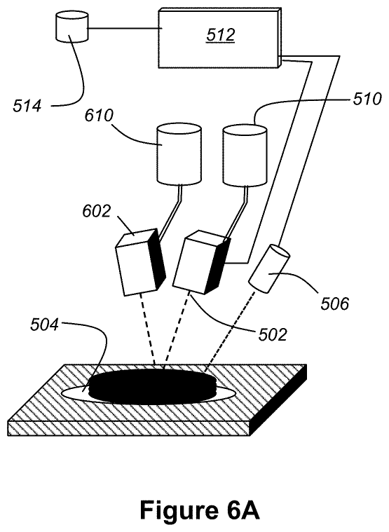

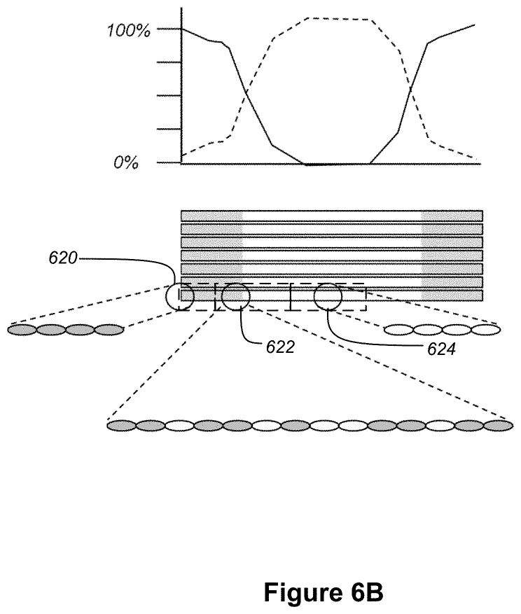

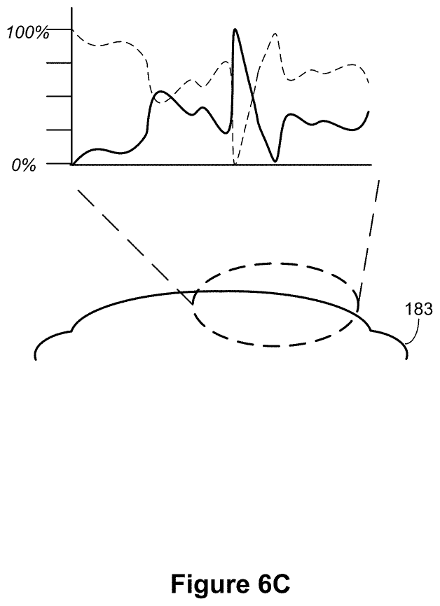

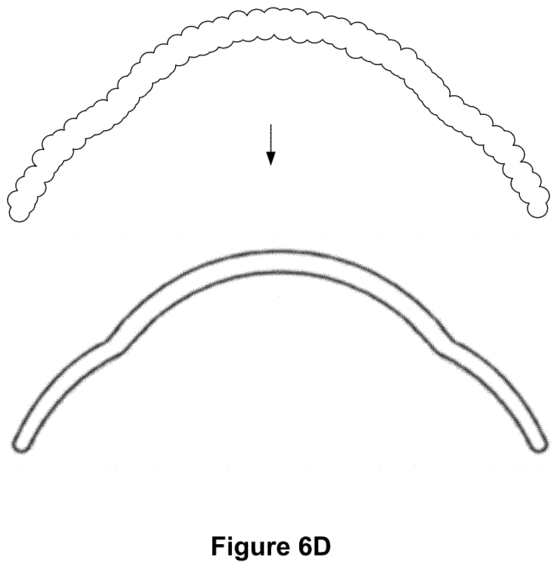

FIG. 6A is a schematic diagram illustrating a three-dimensional (3D) printer for depositing two or more materials in accordance with some embodiments.

The 3D printer shown in FIG. 6A has multiple print heads 502 (or multiple nozzles in one or more print heads 502). The different nozzles can be used to deposit different materials.

The different materials can be applied in different layers or can be deposited adjacently to each other and/or mixed with each other within each printed layer.

FIG. 6A shows a 3D printer having multiple print heads 502 and 602. Each print head deposits a layer of a lens material into the mold that is shaped for the anterior or posterior side of the patient lens. The first print head 502 is coupled to a first reservoir 510 containing a first lens material and deposits the first lens material, and the second print head 602 is coupled to a second reservoir 610 containing a second lens material different from the first lens material and deposits the second lens material. Each lens material is curable to form the lens with the variable refractive index. The second lens material may have a different refractive index from that of the first lens material.

Similar to the 3D printer shown in FIG. 5A, a radiation source 506 (e.g., a UV laser or other high-energy light source) provides the curing energy for the deposited material. Alternatively, a chemical agent can be selectively applied to the layer for curing. Either the mold 504 or the print heads 502 and 602/radiation source 506 or both are on a movable stage that allows deposition and scanning of the layer for curing. The print heads 502 and 602 deposit each layer, then the deposited material is cured, voxel by voxel, to form the lens.

A hybrid combination of fabrication using different materials and variable curing energy can be used for providing a lens with a pattern of variable refractive index profile.

In some embodiments, the 3D printer shown in FIG. 6A can eject droplets of different sizes for the first and second materials. In some embodiments, the two materials can be subject to different process parameters, including print speed, curing time, curing temperature, optimum wavelength range for curing, and other characteristics.

A graph in FIG. 6B shows percentages of first and second materials across a region within a deposited layer. A cross-sectional view shows the layered arrangement and enlarged views of portions of a layer formed by a combination of two materials. In FIG. 6B, Portion 620 of the contact lens (or a deposited layer thereof) contains the first material only, portion 624 of the contact lens (or a deposited layer thereof) contains the second material only, and portion 622 of the contact lens (or a deposited layer thereof) contains a mixture of the first material and the second material. When the first material and the second material have difference refractive indices, a non-constant refractive index profile of the contact lens can be obtained by changing the ratio of the first material and the second material across the contact lens, as shown in FIG. 6B.

FIG. 6C is a schematic diagram illustrating another example of material composition across a contact lens in accordance with some embodiments. The graph in FIG. 6C shows percentages of first and second materials across a region in the contact lens. When the first material and the second material have difference refractive indices, a non-constant refractive index profile of the contact lens is obtained by changing the ratio of the first material and the second material across the contact lens, and the non-constant refractive index profile compensates for higher-order aberrations. As described with respect to FIGS. 3C and 3D, the non-constant refractive index profile can be positioned offset from a center of the contact lens. The non-constant refractive index profile can be placed in a single focal contact lens or a multifocal contact lens.

FIG. 6D is a schematic diagram illustrating surface smoothing of a contact lens formed by an additive fabrication process in accordance with some embodiments. In some embodiments, a contact lens fabricated by an additive fabrication process may have a surface roughness higher than a conventional contact lens. The contact lens fabricated by an additive fabrication process can be processed to reduce its surface roughness. In some embodiments, the contact lens fabricated by an additive fabrication process is thermally treated so reduce the surface roughness. In some embodiments, the contact lens fabricated by an additive fabrication process is coated with an additional coating material (e.g., hydrogel) to reduce the surface roughness. In some embodiments, the contact lens fabricated by an additive fabrication process is mechanically or chemically processed (e.g., polished) to reduce the surface roughness.

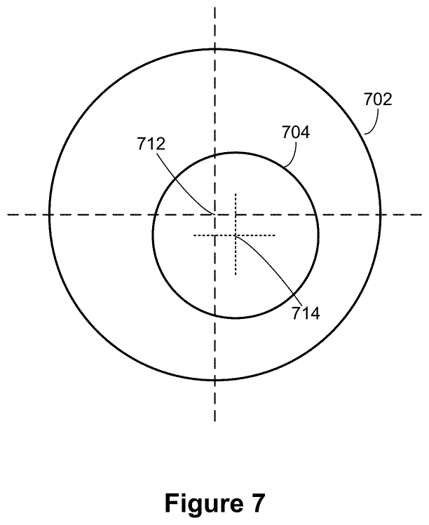

FIG. 7 is a schematic diagram illustrating an offset of a correction region of a contact lens in accordance with some embodiments. For the reasons described with respect to FIGS. 3A-3F, in some embodiments, a correction pattern (e.g., a non-constant refractive index profile) is positioned offset from a center 712 of a contact lens 702. For similar reasons, in such embodiments, a center 714 of a correction region 704 (including the correction pattern) is positioned offset from the center 712 of the contact lens 702.

A Scleral Lens, also known as a scleral contact lens, is designed to help compensate or correct for a variety of eye conditions, including Keratoconus and severe eye dryness. Unlike soft contact lenses, scleral lenses tend to maintain their physical structure when in position against the eye (instead of conformance to the ocular surface). Scleral lenses can provide effective tear management and refractive index matching.

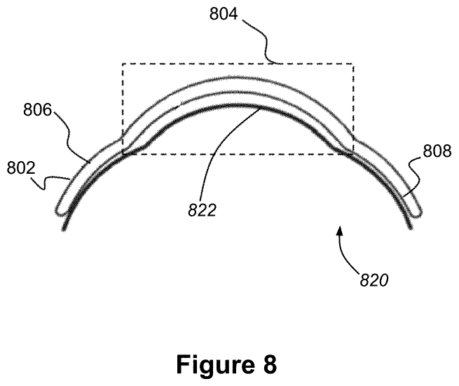

FIG. 8 is a schematic diagram illustrating a cross-sectional view of a scleral contact lens 802 in accordance with some embodiments.

In FIG. 8, the scleral lens 802 is seated on an eye 820. The scleral lens 802 is typically a large-diameter gas permeable contact lens with a lensing portion 804 that vaults over the wearer's corneal surface 822 and a haptic portion 806.

The scleral lens 802 is designed and positioned to provide a smooth optical surface in the lensing portion 804 for vision compensation. The haptic portion 806 forms a supporting skirt or ring around the periphery of the lensing portion 804 and resting on the sclera (the white portion of the eye 820), and the haptic portion 806 includes a haptic surface H that comes in contact with the sclera when the scleral lens 802 is positioned on the eye.

In some embodiments, the haptic portion 806 is made of a softer material than the harder lensing portion 804 so that the haptic portion 806 provides more comfort to the wearer and to reduce blanching and related problems where the supporting structure of the lens 802 seats against the eye 820. For example, the haptic surface 808 is made of a softer and more flexible material, having a lower stiffness or modulus value, than the material for the lensing portion 804 (e.g., the lensing portion 804 is made by additive fabrication process using two different materials and the haptic portion 806 is made of a third material that is different from the two different materials used for making the lensing portion 804 and has a lower stiffness than the lensing portion 804). In some embodiments, the haptic portion 806 is formed by additive fabrication process (e.g., by continuing additive fabrication process on the lensing portion 804 after the lensing portion 804 is formed). In some embodiments, the haptic portion 806 is formed separately from the lensing portion 804 and the haptic portion 806 and the lensing portion 804 are bonded to form the lens 802 (e.g., using a bonding material that may be the same as any one of the two different materials used for forming the lensing portion 804, the third material, or any combination thereof, or any material different from the two different materials and the third material).

In some embodiments, the haptic portion 806 and the lensing portion 804 are made of same or similar materials. However, the haptic portion 806 is hydrated to reduce its stiffness while hydration of the lensing portion 804 is reduced or avoided to maintain its stiffness.

Thus, in some embodiments, the 3D printers described herein can be used to form a scleral lens, but where the haptic surface 808 is made of more flexible material than the material of the lensing portion 804. For example, different materials may be deposited or used in varying proportions for providing increasing stiffness in a direction toward the center axis of the lens, with decreasing stiffness towards the outer edges of the lens. In some cases, the stiffness changes gradually or continuously over a boundary between the lensing portion 804 and the haptic portion 806. In another example, a first group of materials is used to form the lensing portion 804 and a second group of material distinct from the first group of materials is used to form the haptic portion 806 so that the haptic portion 806 and the lensing portion 804 have different stiffness. In some cases, the stiffness changes abruptly over a boundary between the lensing portion 804 and the haptic portion 806.

In some embodiments, variable curing energy is used to change the stiffness or Young's modulus of the haptic portion 806. It is known that modulating the curing energy from a light source to a polymer material (or its monomer precursor) can affect stiffness aspects of the material. Thus, by adjusting the light intensity or duration, for example, the fabrication process can be manipulated to impart different degrees of flexibility or stiffness to the same polymer. This stiffness variability can be achieved over different portions of a monolithic lens.

In some embodiments, a scleral lens 802 having different stiffness between the lensing portion 804 and the haptic portion 806 has a non-constant refractive index profile described herein. In some embodiments, a scleral lens 802 having different stiffness between the lensing portion 804 and the haptic portion 806 has a constant refractive index profile across the lens 802.

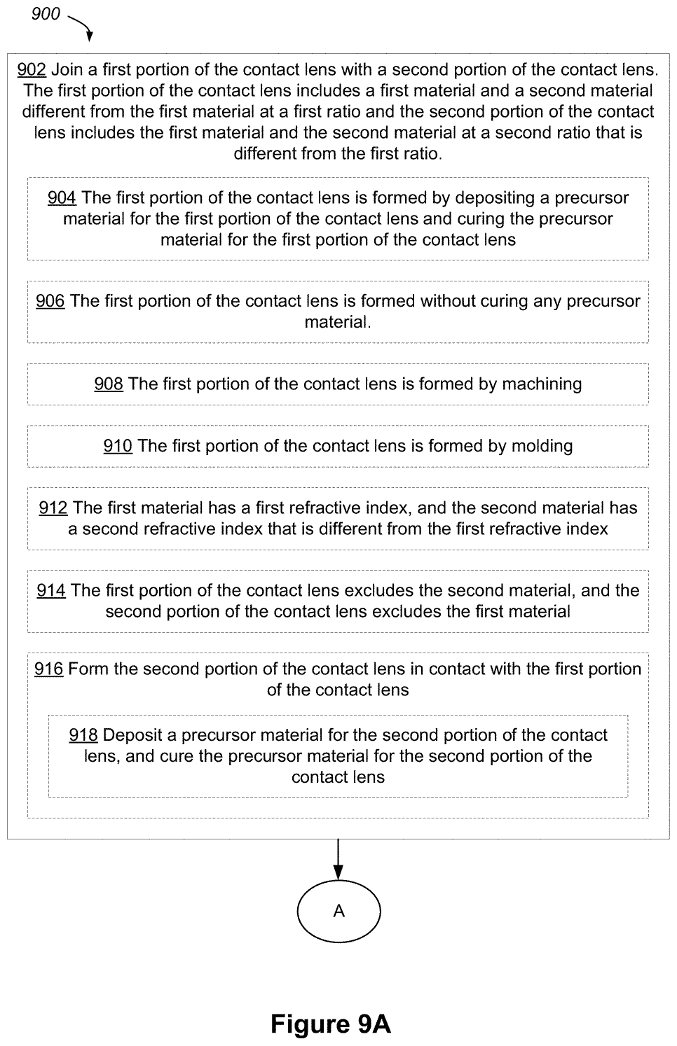

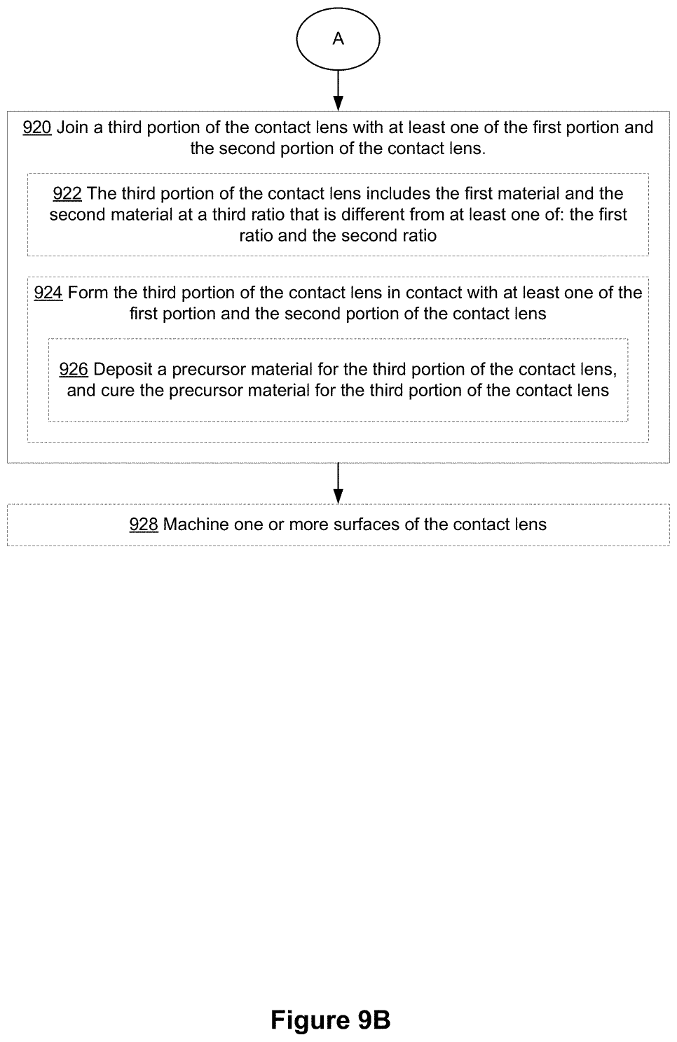

FIGS. 9A-9B are flow diagrams illustrating a method 900 of fabricating a contact lens by an additive fabrication process in accordance with some embodiments.

The method 900 includes fabricating a contact lens by an additive fabrication process, including (902) joining a first portion of the contact lens with a second portion of the contact lens. The first portion of the contact lens includes a first material and a second material different from the first material at a first ratio (e.g., a ratio ranging from 0:100 to 100:0) and the second portion of the contact lens includes the first material and the second material at a second ratio (e.g., a ratio ranging from 100:0 to 0:100) that is different from the first ratio. For example, portion 522 is joined with portion 520 as shown in FIG. 5B. In another example, portion 622 is joined with portion 620 (directly or indirectly) as shown in FIG. 6B. The different ratios of the two materials provide a refractive index profile for correction of higher-order aberrations, as described above with respect to FIG. 6C.

In some embodiments, the first portion of the contact lens is formed (904) by depositing a precursor material (e.g., monomers) for the first portion of the contact lens, and curing the precursor material for the first portion of the contact lens. In some embodiments, curing the precursor material converts monomers to polymers.

In some embodiments, the first portion of the contact lens is formed (906) without curing any precursor material. For example, the first portion of the contact lens is premade without using a 3D printer.

In some embodiments, the first portion of the contact lens is formed (908) by machining (e.g., the first portion of the contact lens is formed by cutting a substrate using a lathe, a milling machine, or any other cutting tools).

In some embodiments, the first portion of the contact lens is formed (910) by molding. In some embodiments, the first portion of the contact lens is formed by a combination of molding and machining (e.g., cutting a molded component).

In some embodiments, (912) the first material has a first refractive index, and the second material has a second refractive index that is different from the first refractive index. For example, the first material is a hydrogel having a refractive index of approximately 1.33 and the second material is a nanoparticle having a refractive index of approximately 2.

In some embodiments, (914) the first portion of the contact lens excludes the second material (e.g., the first portion is filled with 100% of the first material), and the second portion of the contact lens excludes the first material (e.g., the second portion is filled with 100% of the second material).

In some embodiments, joining the first portion of the contact lens with the second portion of the contact lens includes (916) forming the second portion of the contact lens in contact with the first portion of the contact lens. For example, as shown in step S512 of FIG. 5B, the portion 522 is formed in contact with the portion 520.

In some embodiments, forming the second portion of the contact lens includes (918) depositing a precursor material for the second portion of the contact lens, and curing the precursor material for the second portion of the contact lens. For example, as shown in step S512 of FIG. 5B, the portion 522 is formed by depositing a precursor material in contact with the portion 520 and curing the precursor material.

Fabricating the contact lens by the additive fabrication process also includes, subsequent to joining the first portion of the contact lens with the second portion of the contact lens, (920) joining a third portion of the contact lens with at least one of the first portion and the second portion of the contact lens (e.g., joining the portion 524 to the portion 520).

In some embodiments, (922) the third portion of the contact lens includes the first material and the second material at a third ratio (e.g., a ratio ranging from 0:100 to 100:0) that is different from at least one of: the first ratio and the second ratio. For example, as shown in FIG. 6B, portions 620, 622, and 624 have different ratios of the first material and the second material.

In some embodiments, joining the third portion of the contact lens includes (924) forming the third portion of the contact lens in contact with at least one of the first portion and the second portion of the contact lens. For example, as shown in step S514 of FIG. 5B, the portion 524 is formed in contact with the portion 520.

In some embodiments, forming the third portion of the contact lens includes (926) depositing a precursor material for the third portion of the contact lens; and curing the precursor material for the third portion of the contact lens. For example, as shown in step S514 of FIG. 5B, the portion 524 is formed by depositing a precursor material in contact with the portion 520 and curing the precursor material.

In some embodiments, the method also includes (928) machining one or more surfaces of the contact lens. For example, the contact lens made by the additive fabrication process may be machined (e.g., polished, lathed, milled, etc.) to reduce the surface roughness and/or to add additional features.

In some embodiments, a center of a correction region of the contact lens is offset from a center of the contact lens (e.g., FIG. 7).

In some embodiments, at least one of the first portion, the second portion, and the third portion of the contact lens includes hydrogel. In some embodiments, all of the first portion, the second portion, and the third portion of the contact lens include hydrogel.

In some embodiments, a center region of the contact lens has a first stiffness, and a peripheral region of the contact lens has a second stiffness less than the first stiffness (e.g., the lensing portion 804 shown in FIG. 8 has a higher stiffness than the haptic portion 806 so that the lensing portion 804 maintains the optical surface while the haptic portion 806 provides a softer surface for contact with the sclera).

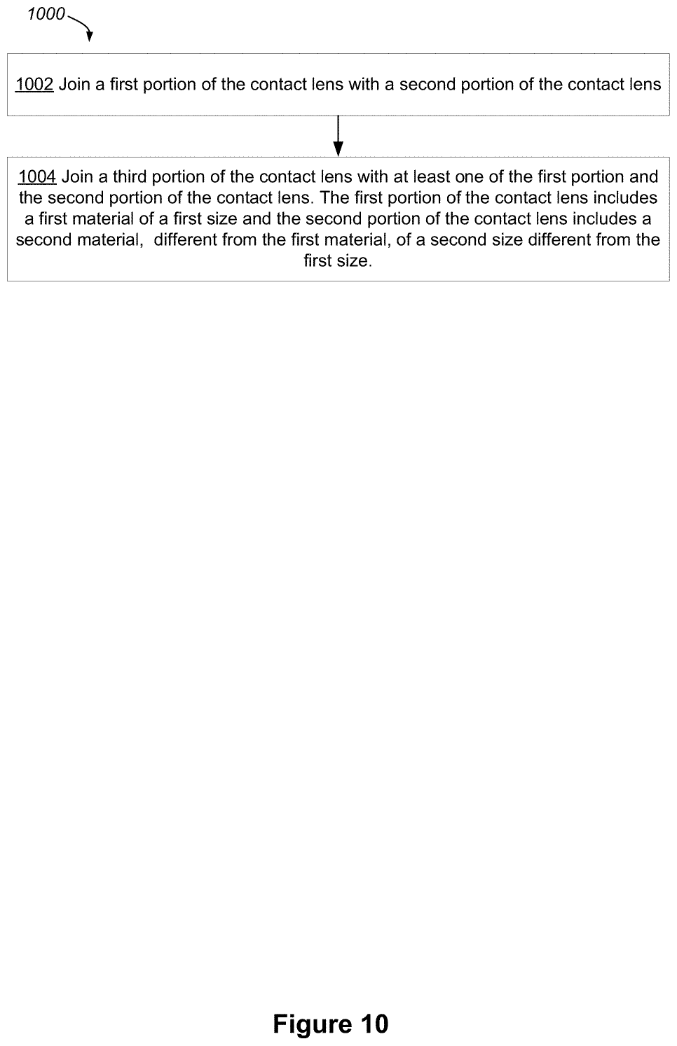

In some embodiments, the method 900 has one or more features described with respect to FIGS. 10, 11, and 12. For brevity, such details are not repeated herein.

FIG. 10 is a flow diagram illustrating a method 1000 of fabricating a contact lens by an additive fabrication process in accordance with some embodiments.

The method 1000 includes fabricating a contact lens by an additive fabrication process, including (1002) joining a first portion of the contact lens with a second portion of the contact lens, and subsequent to joining the first portion of the contact lens with the second portion of the contact lens, and (1004) joining a third portion of the contact lens with at least one of the first portion and the second portion of the contact lens. The first portion of the contact lens includes a first material of a first size and the second portion of the contact lens includes a second material, different from the first material, of a second size different from the first size. For example, the portion 520 and the portion 522 shown in FIG. 5B may have different sizes.

In some embodiments, the method 1000 has one or more features described with respect to FIGS. 9, 11, and 12. For brevity, such details are not repeated herein.

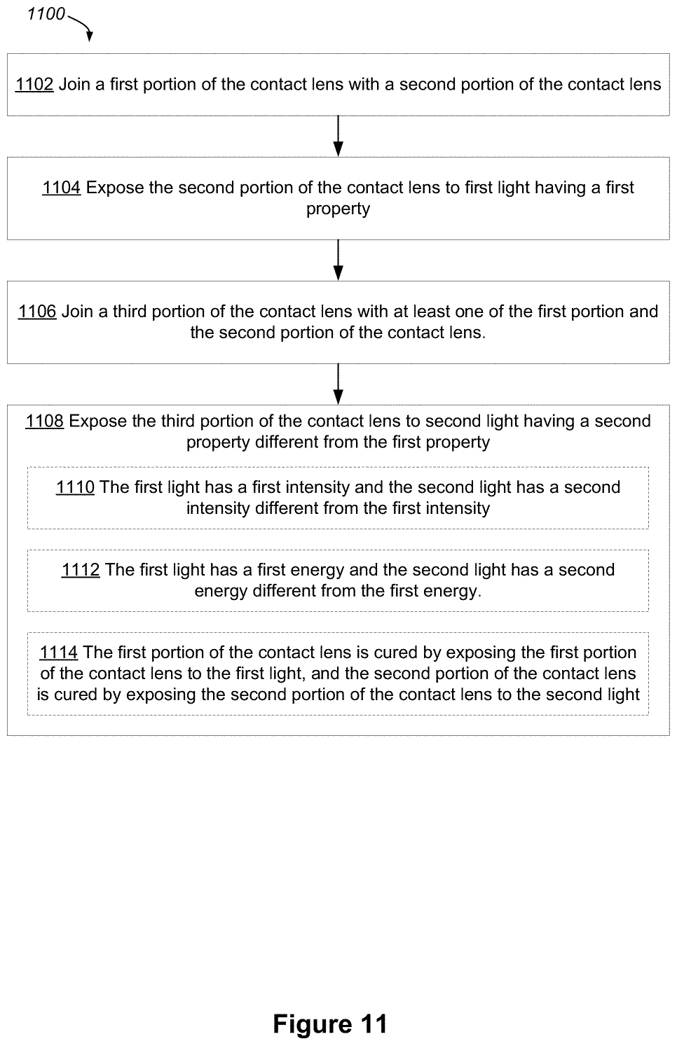

FIG. 11 is a flow diagram illustrating a method 1100 of fabricating a contact lens by an additive fabrication process in accordance with some embodiments.

The method 1100 includes fabricating a contact lens by an additive fabrication process, including (1102) joining a first portion of the contact lens with a second portion of the contact lens (e.g., depositing the second portion in contact with the first portion); (1104) exposing the second portion of the contact lens to first light having a first property (e.g., first intensity); subsequent to joining the first portion of the contact lens with the second portion of the contact lens, (1106) joining a third portion of the contact lens with at least one of the first portion and the second portion of the contact lens (e.g., depositing the third portion in contact with the first portion, the second portion, or both); and (1108) exposing the third portion of the contact lens to second light having a second property (e.g., second intensity) different from the first property. Exposure to light having different light properties generates a refractive index profile for correction of the higher-order aberrations.

In some embodiments, (1110) the first light has a first intensity and the second light has a second intensity different from the first intensity.

In some embodiments, (1112) the first light has a first energy and the second light has a second energy different from the first energy.

In some embodiments, the first light has a first wavelength range and the second light has a second wavelength range different from the first wavelength range.

In some embodiments, (1114) the second portion of the contact lens is cured by exposing the second portion of the contact lens to the first light; and the third portion of the contact lens is cured by exposing the third portion of the contact lens to the second light.

In some embodiments, the method includes joining a fourth portion of the contact lens (e.g., the portion 526 in FIG. 5B) to at least one of the first portion, the second portion, and the third portion, and exposing the fourth portion of the contact lens to third light having a third property different from at least one of the first property and the second property.

In some embodiments, the method 1100 has one or more features described with respect to FIGS. 9, 10, and 12. For brevity, such details are not repeated herein.

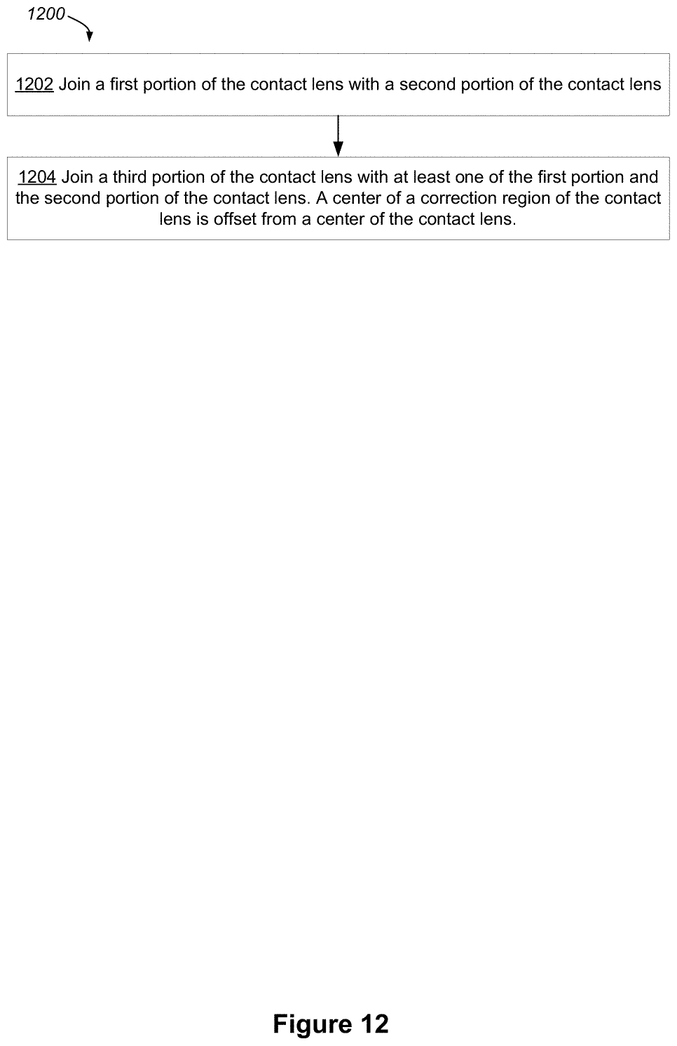

FIG. 12 is a flow diagram illustrating a method 1200 of fabricating a contact lens by an additive fabrication process in accordance with some embodiments.

The method 1200 includes fabricating a contact lens by an additive fabrication process, including (1202) joining a first portion of the contact lens with a second portion of the contact lens, and subsequent to joining the first portion of the contact lens with the second portion of the contact lens, joining a third portion of the contact lens with at least one of the first portion and the second portion of the contact lens. A center of a correction region of the contact lens is offset from a center of the contact lens (e.g., FIG. 7).

In some embodiments, the method 1200 has one or more features described with respect to FIGS. 9, 10, and 11. For brevity, such details are not repeated herein.

In accordance with some embodiments, a contact lens is made by any method described herein. In some embodiments, the contact lens includes a scleral lens.

The foregoing description, for purpose of explanation, has been described with reference to specific embodiments. However, the illustrative discussions above are not intended to be exhaustive or to limit the scope of claims to the precise forms disclosed. Many modifications and variations are possible in view of the above teachings. The embodiments were chosen and described in order to best explain the principles of the various described embodiments and their practical applications, to thereby enable others skilled in the art to best utilize the invention and the various described embodiments with various modifications as are suited to the particular use contemplated.

What is claimed is:

1. A method, comprising:
fabricating a contact lens by an additive fabrication process, including:
joining a first portion of the contact lens with a second portion of the contact lens;
subsequent to joining the first portion of the contact lens with the second portion of the contact lens, joining a third portion of the contact lens with at least one of the first portion and the second portion of the contact lens,
wherein the first portion of the contact lens has a first refractive index and the second portion of the contact lens has a second refractive index that is different from the first refractive index.

2. The method of claim 1, wherein a center of a correction region of the contact lens is offset from a center of the contact lens.

3. The method of claim 1, wherein the first portion of the contact lens includes a first material and a second material different from the first material at a first ratio and the second portion of the contact lens includes the first material and the second material at a second ratio that is different from the first ratio.

4. The method of claim 3, wherein:
the first material and the second material have different refractive indices.

5. The method of claim 3, wherein:
the first portion of the contact lens excludes the second material; and
the second portion of the contact lens excludes the first material.

6. The method of claim 3, wherein:
the third portion of the contact lens includes the first material and the second material at a third ratio that is different from at least one of: the first ratio and the second ratio.

7. The method of claim 1, wherein the first portion of the contact lens includes a first material of a first size and the second portion of the contact lens includes a second material, different from the first material, of a second size different from the first size.

8. The method of claim 1, further comprising:
exposing the second portion of the contact lens to first light having a first property; and
exposing the third portion of the contact lens to second light having a second property different from the first property.

9. The method of claim 8, wherein the first light has a first intensity and the second light has a second intensity different from the first intensity.

10. The method of claim 8, wherein the first light has a first energy and the second light has a second energy different from the first energy.

11. The method of claim 8, wherein:
the first portion of the contact lens is cured by exposing the first portion of the contact lens to the first light; and
the second portion of the contact lens is cured by exposing the second portion of the contact lens to the second light.

12. The method of claim 8, including:
joining a fourth portion of the contact lens with at least one of the first portion, the second portion, and the third portion; and
exposing the fourth portion of the contact lens to third light having a third property different from at least one of the first property and the second property.

13. The method of claim 1, wherein:
at least one of the first portion, the second portion, and the third portion of the contact lens includes hydrogel.

14. The method of claim 1, wherein joining the first portion of the contact lens with the second portion of the contact lens includes forming the second portion of the contact lens in contact with the first portion of the contact lens.

15. The method of claim 14, wherein:
forming the second portion of the contact lens includes:
depositing a precursor material for the second portion of the contact lens; and
curing the precursor material for the second portion of the contact lens.

16. The method of claim 14, wherein joining the third portion of the contact lens includes forming the third portion of the contact lens in contact with at least one of the first portion and the second portion of the contact lens.

17. The method of claim 16, wherein:
forming the third portion of the contact lens includes:
depositing a precursor material for the third portion of the contact lens; and
curing the precursor material for the third portion of the contact lens.

18. The method of claim 1, wherein:
the first portion of the contact lens is formed by:
depositing a precursor material for the first portion of the contact lens; and
curing the precursor material for the first portion of the contact lens.

19. The method of claim 1, wherein:
the first portion of the contact lens is formed without curing any precursor material.

20. The method of claim 1, wherein:
a center region of the contact lens has a first stiffness; and
a peripheral region of the contact lens has a second stiffness less than the first stiffness.
